(19) United States
(12) Patent Application Publication
(10) Pub. No.: US 2015/0128020 A1
(43) Pub. Date: May 7, 2015

(54) SYSTEM AND METHOD FOR COLLABORATION BASED ON GEOGRAPHICAL LOCATION

(71) Applicants: Oscar Garcia Chávez, San Pedro Garza Garcia (MX); Homero Valle Lozano, San Pedro Garza Garcia (MX)

(72) Inventors: Oscar Garcia Chávez, San Pedro Garza Garcia (MX); Homero Valle Lozano, San Pedro Garza Garcia (MX)

(21) Appl. No.: 14/070,552

(22) Filed: Nov. 3, 2013

(51) Int. Cl. G06F 17/24; G06F 17/22

(52) U.S. Cl. CPC G06F 17/241; G06F 17/2247; G06F 17/2235
USPC 715/230

(57) ABSTRACT

A system and method for collaboration based on geographical location are disclosed. A particular embodiment includes: generating, by execution of a data processor, a user interface for creating and viewing notes, the user interface including a digital map and a console; creating, by use of tools provided by the console, a note having an author, a title, and content; specifying on the digital map a first geographical location (geo-location) associated with the note; displaying a first icon on the digital map at the first geo-location corresponding to the geo-location associated with the note; determining if there is a plurality of notes associated with geo-locations that are within a pre-determined distance from the first geo-location; and replacing the first icon with a second icon that indicates the quantity of notes associated with the first geo-location, if there is a plurality of notes associated with geo-locations that are within a pre-determined distance from the first geo-location.

### TECHNICAL

This patent application relates to computer-implemented software and networked systems, according to one embodiment, and more specifically to a system and method for collaboration based on geographical location.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent tiles or records, but otherwise reserves all copyright rights whatsoever. The following notice applies to the software and data as described below and in the drawings that form a part of this document: Copyright 2012-2013 Likter Inc., All Rights Reserved.

### BACKGROUND

Online social networking is widely used by users to make connections to new contacts and remain connected with their existing contacts. For example, a user may register for an account with an online social networking site, such as Facebook™, and post a profile on the site so that other users may get to know him/her. The user may also post messages, photos, videos, or other files, on the site. The user may add other users on the same social networking site to his/her list of contacts, so that these contacts my view his/her posts on the site. For instance, the user may add people she knows in real life, such as his/her family members, relatives, and friends, to his/her list of contacts. Once a person is added as a contact, the user may be allowed to see the list of contacts of this person, and s/he may decide to add some of that person's contacts as his/her own contacts.

Given the large number of people all over the world to whom one could potentially connect on a social networking site the user's list of contacts can grow rapidly. Furthermore, it is common for a user to have several social networking accounts on different social networking sites. For example, one may have a Facebook™ account, a Twitter™ account, of LinkedIn™ account, and other accounts. With more networks, and more contacts per network, it becomes difficult to keep track of the network content posted by all contacts, such content including messages, articles, photos, videos, etc. In addition, because the contacts and network content are maintained on the online sites, a user may not have a desired level of control over the privacy of the contacts and content. Further, many websites do not have robust and consistent support fur mobile devices.

Smart phones are becoming the predominant link between data and people. Additionally, data and information storage is changing. Network cloud data storage is becoming increasingly acceptable to consumers and is quickly becoming the data storage location of choice. However, large social networks are experiencing fatigue and consumers are looking for new ways to network while maintaining control over their privacy and the security of their data. In many cases, users may want to limit the scope of their social networks to the relationships that mean the most to them or the relationships and information they are most likely to trust. Often, geographical proximity is an important factor in determining the significance of these relationships and the information that users find most relevant and useful. Unfortunately, the tools are lacking for managing these relationships and information sources from a geographical perspective.

### BRIEF DESCRIPTION OF THE DRAWINGS

The various embodiments are illustrated by way of example, and not by way of limitation, in the figures of the accompanying drawings in which:

FIG. 1 illustrates an example embodiment of a collaboration system based on geographical location;

FIG. 2 illustrates an example embodiment, implemented as a web application (app), that shows the basic elements of the user interface;

FIG. 3 illustrates another example user interface snapshot, implemented as a web app, that shows the map and console of an example embodiment;

FIG. 4 illustrates the Alerts tool of an example embodiment;

FIG. 5 illustrates the Colleagues tool of an example embodiment;

FIG. 6 illustrates the My Notes tool of an example embodiment;

FIG. 7 illustrates the Profile tool of an example embodiment;

FIG. 8 illustrates the Write tool of an example embodiment;

FIG. 9 illustrates an example user interface snapshot, implemented as a web app, that shows the basic elements of the user interface for viewing and manipulating notes in an example embodiment;

FIGS. 10 and 11 illustrate example user interface snapshots, implemented as a web app, that show the voting features of the user interface of an example embodiment;

FIGS. 12 through 18 illustrate example user interface snapshots, implemented as a web app, that show additional elements of the user interface for viewing and manipulating notes in an example embodiment;

FIG. 19 illustrates an example embodiment that shows a situation when a note is too long to be read in the note detail window;

FIGS. 20 through 29 illustrate example user interface snapshots, implemented as a mobile application (app), that show the basic elements of the user interface for viewing and manipulating notes on a mobile device in an example embodiment;

FIGS. 30 through 32 illustrate example user interface snapshots, implemented as a web application, that show the basic elements of the user interface for displaying advertisements (ads) in an example embodiment;

FIG. 33 illustrates another example embodiment of a networked system in which various embodiments may operate;

FIG. 34 is a processing flow chart illustrating an example embodiment of as method as described herein; and

FIG. 35 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for collaboration based on geographical location are disclosed. The various embodiments provide the ability for improved social, commercial, and professional interaction or collaboration between communities of users with tools enabling information sharing focused on the geographical location (geo-location) of the users involved. In the collaboration and the geo-location associated with the shared information. In various embodiments described in detail below, a software application program is used to generate and enable the geo-location based collaboration interface using a computer system, a web appliance, and/or a mobile device. As described in more detail below, the computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

### Overview of an Example Embodiment

An example embodiment as described herein is a collaboration network focused on the creation and dissemination of information, news, or other content reported by community users, in real time and filtered by geo-location. This form of geo-location based interaction allows the creation of communities that share information on relevant events or topics of interest at relevant geo-locations, without having to resort to traditional means. An example embodiment provides a virtual community and a way of automating and enhancing the process of the production and consumption of news through the creation and publication of notes and the perspectives and opinions related to the notes. In addition to creating notes, users also regulate the degree of accuracy of the information generated and disseminated. An example embodiment provides this virtual community through the system's ability to catalog the notes according to their degree of relevance based on a variety of factors, including the geographical location of the originator and/or a geographical location associated with the note.

In various embodiments, a note is a user-generated compilation of information and/or content that may include text, links, images, video, audio, executable code, interpretable code, other types of network-transportable content, and/or a combination thereof. In an example embodiment, notes are generated by users. Each note can be associated with a geographical location, labels, tags, or other meta data, which can be used to classify, categorize, and/or filter the note. An associated icon or other marking or display object associated with the note may be located geographically and shown on the map. Other features of notes in various embodiments are described in more detail below.

The geographical filter of the example embodiment is implemented by integrating a geographical map, in which it is possible to locate the exact location of an event or topic of interest. The geographical filter enables the user view the stories or other content reported near the user's location or the geographical area specified by the user. The example embodiment provides a platform that responds to new trends and the immediacy in the way we consume news, emphasizes the social aspect, and simultaneously serves the local and the global communities.

Consistent with the new models of production and consumption of information, the example embodiment provides a platform where users themselves have control over the type of notes or other content that is produced and the manner in which the content is disseminated, regardless of the structures and limitations imposed by traditional media.

### Interface

The functionality of an example embodiment provides two basic elements: 1) a geographical map, and 2) a console or user platform with a user interface from which the user can access the various tools provided by the site or the application. Additionally, there is a menu bar where the user can make a donation, check notifications, place the map in the desired geographical location, consult the help menu, or exit from the user's account.

### Map

In an example embodiment, the geographical map acts as a filter that allows the user to see the notes or other content relevant to their geographical location in real time. The map of a particular default location can be declared by the user when setting up their account. The default location can be modified using a profile tool. In an example embodiment, the user can scroll the map and zoom in and out using a navigation tool located in the lower right corner of a display screen of the user platform (or using any other means to manipulate the map, e.g., scrolling the mouse up or down, using hot-keys etc). The map shows detailed information about the selected location. The user can also see icons or markers that indicate the sites (geo-locations) where other users have created notes. When the user selects a note icon on the map, the user can see a preview of the selected note with the title of the note, an indication of related notes, and an indication of the type of content of the note that may include text, links, images, video, audio, executable code, interpretable code, other types of content, and/or a combination thereof. If the user wants to see the complete note, the user merely selects the title of the note and the complete content of the note is viewable.

### Console

The console of an example embodiment can be implemented as a user interface on a user platform. The various types of user platforms are described in more detail below. The console of an example embodiment is made up of three parts: a search engine, a toolbar (Toolbar), and a portion of the user interface in which information is displayed according to a user selected tool. The search engine allows the user to perform a search for notes by keywords (e.g., terms used in the title, content, or meta data of the note that match a search query), or a search for a specific geographical location and cause the display of all notes associated with that geo-location. The toolbar (Toolbar) shows four tool icons at all times of the nine tools available to users in the example embodiment. The user can arrange the order in which the tool icons appear and manipulate a slidebar to display the remaining tool icons.

### Menu Bar

The menu bar of an example embodiment is visible at all times and has the following elements: an icon in the form of a heart, an Alerts tool icon, the user name of the account in use, the geographical location associated with the account in use, an About section, and the function enabling the user to log in. The heart-shaped icon opens a window or other user interface display region from which the user can make a donation from $1 USD to $100 USD via PayPal™ or Google™ Wallet. The Alerts tool icon opens a display with all user notifications. The user name of the account in use identifies the name of the user account currently in use. The Profile tool opens the console and allows the user to change the details of the user account. The default map geo-location can be set by the user using the Profile tool. In one embodiment, the system automatically obtains the geographical location of the user (with user permission) when the user initially enters the site. In the case where the user has not set a default location, the system redirects the map towards the geographical area that was initially obtained for the user.

### Notes

The core of the user experience in the geo-location based collaboration system of an example embodiment is focused on the generation, searching, filtering, and viewing of notes. In various embodiments, a note is a user-generated compilation of information and/or content that may include text, links, images, video, audio, executable code, interpretable code, other types of content, and/or a combination thereof. In an example embodiment, notes are generated by users. Each note can be associated with a geographical location and an associated icon or other marking associated with the note may be located geographically on the map. The functionality of the example embodiment provides several ways to view this note content. For example, the notes are accessible from the map or from the console. On the map, the geographical location associated with the note can correspond to a geo-location where an event occurred that is related to the note. The correlation between the location on the map and the corresponding note represented on the console is shown when placing the mouse pointer over the note object represented on the console. In response to this action, the color (or intensity) of the note icon on the map corresponding to the note represented on the console is modified to show the relationship between the note object represented on the console and the corresponding note icon represented on the map. Conversely, the correlation between the location on the map and the corresponding note represented on the console is also shown when placing the mouse pointer over the note icon on the map. In response to this action, the color (or intensity) of the note object represented on the console corresponding to the note represented on the map is modified to show the relationship between the note object represented on the console and the corresponding note icon represented on the map. Using the map, a user can click on an icon or other marking associated with the note and get access to the content of the note. Using the console, the user can search for notes using a content query, filter notes using a filtering tool, obtain access to notes via a recommendation from others, or obtain access to notes through a live feed.

By deploying or obtaining a note, a user has several ways to interact with the content of the note. For example, in the header (also denoted the preview or summary) of the note, the header includes the picture of the user who created the note, the title of the note, the user name of the user who created the note, and the age or time/date associated with the note. Below the content of the note, the note includes labels, tags, captions, or other meta data, which can be used to classify or categorize the note for more efficient searching and storage. An example embodiment enables a user to view a note and to manipulate or interact with a note in a variety of ways, including: adding comments to a note, opening the note in a new browser tab, saving the note to read later, sharing the note with friends by using the Bounce feature of the example embodiment, reporting the note to a host authority as containing inappropriate content, and recording the user's opinion as to the degree of accuracy or veracity of the note (e.g., the note is false (Fake button) or the note is true (True button)). In an example embodiment, the note interaction options appear in a lateral stripe, which also displays a list of related notes. In the case of opening the note in a separate tab, an example embodiment adds the ability to print the note (e.g., Print this note). The notes can be classified into the following predefined categories: Arts and Culture, Business, Entertainment, Food, Health, Opinion, Politics, Public Safety, Science and Nature, Sports, Technology, Travel, Weather. It will be apparent to those of ordinary skill in the art that a variety of other categories can equivalently be used.

### Tools: Alerts

The Alerts tool of an example embodiment works as a notification center, which can be used to show as user the notes that have been recommended by another user (colleague) using the Bounce function and other aspects of relevance.

### Tools: Colleagues

The Colleagues tool of an example embodiment enables a user to manage a contact list in an example embodiment. A user can find contacts or enter new contacts by name and location.

### Tools: Filter

The Filter tool of an example embodiment enables a user to create filters that apply certain conditions to manage the notes that appear to the user. The user can name each filter and establish filtering criteria that specify limiting conditions to enable the embodiment to select only particular notes that meet the specified limiting conditions. These filtering criteria can include: select only notes that contain certain keywords selected by the user; select only notes issued by one or more of the user-defined colleagues; select only notes associated with a particular geographical area; and the like. It will be apparent to those of ordinary skill in the art that a variety of other filtering criteria can equivalently be used.

### Tools: Live

The Live tool of an example embodiment enables a use to view a live feed of the most recent notes corresponding to a portion of the map that is visible on the display screen at the time. Notes that are included in the live feed can be filtered based on user preferences and active filters configured with the Filter tool. The user can select how often to refresh the list of most recent notes from ten seconds to a minute. The list of notes in the live feed can include for each note the note author's name, a picture of the note's author, the title of the note, the age or time/date associated with the note, an indication of the level of reliability (veracity) of the note, and the first words of the textual content of the note. If the user moves a cursor (or otherwise manipulates a pointing device) over one of the notes in the feed, a set of options is automatically displayed to enable the user to qualify the note as true or false, save the note to read later, or share the note using the Bounce function (described below). If the user decides to share the note, a small window is opened to allow the user to select the colleagues with whom the note is shared.

### Tools: My Notes

The My Notes tool of an example embodiment enables a user to archive all of the notes written by the user. The user interface of the My Notes tool of an example embodiment is divided into two tabs: Published and Drafts. The Published tab displays all published notes of the user; the Drafts tab displays all un-published notes of the user.

### Tools: Profile

The Profile tool of an example embodiment enables a user to edit their profile information. The user can use the Profile tool to, for example, change the picture that identifies the user in the notes originated by the user. The Profile tool can also be used to configure the ability of the social community to view the user's credibility points, which are obtained for participation on the site. In one embodiment, the accumulation of credibility points for a particular user are shown as a progress bar that fills up with green color, indicating that there is a gain in credibility points for the user. Once the bar is filled with the color green, the user will receive a Credibility Badge from a series of available badges or badge types. Then, the color in the progress bar will be cleared and the credibility acquisition process will restart to enable the user to earn another Credibility Badge. The credibility of each user can be measured by the Credibility Badges that he/she has obtained. The Credibility Badges obtained by a particular user can be made visible to other users viewing the particular user's profile. In a particular embodiment. Credibility Badges cannot be configured by the user. A user can only have access to see which Credibility Badges he/she has acquired as a result of getting good feedback from other users who have voted on the veracity of notes originated by the user. Users of a host site may want to get their accounts verified (e.g., the veracity of their originated content validated) to boost their credibility. In order for the host site to provide such validation, the user may be charged a small amount of money to get their account verified. In general. Credibility Badges are recognitions for a user's good performance on the site as measured by the votes of other users. In the example embodiment, another type of badge, a Specialized Badge, is also provided to users. A Specialized Badge is given to a particular user based on the specialized qualifications, expertise, skills, or status of the user as determined by the host administrator. The Specialized Badge verifies the particular user as a reliable source of information. For example, a nuclear physicist would like to have a nuclear physicist badge on his/her profile so she can get more credibility and exposure when there are articles published that are related to this subject. To perform this specialized badge verification, the host might request the specialized user to pay to monetary compensation to have the user's background and expertise verified. Credibility Badges and Specialized Badges can also be shown in combination with an associated note to indicate the reliability or veracity of the in formation in the note.

The Profile tool can also be used to configure the privacy settings for the user. The Profile tool can also be used to configure Badges, which are recognitions for good performance on the site. The Profile tool can also be used to configure the email address associated with the account, password, name, date of birth, language, default geographical location, and other user biographical or configuration information.

### Tools: Saved

The Saved tool of an example embodiment enables a user to save notes, view saved notes, and manage saved notes. This allows the user to see a list of his/her saved notes at any moment and navigate through them and have quick access to them.

### Tools: Top

The Top tool of an example embodiment enables a user to display relevant notes by geographical location or by search criteria. The user can also sort notes by level of veracity or popularity. The Top tool, and other took provided by the example embodiment, enables users to select, filter, and arrange notes in a manner that is most likely to produce a set of information that is most relevant to a particular user. For example, users can view notes that are most geographically relevant. In this manner, users can get information related to events or stories that are close to them. The veracity filtering and sorting also enables users to view the most truthful or most accurate information. Users can also see currently trending information by viewing the most popular notes. Combinations of these tools can produce a highly selective and highly relevant set of notes for a particular user. This highly selective and highly relevant set of notes can be viewed, saved, and shared by the user.

### Tools: Write

The Write tool of an example embodiment enables a user to create or originate notes. The user can use the Write tool to add or edit the text of a note and add other content, such as images, hyperlinks, video, audio, executable code, interpretable code, and the like. The user can also use the Write tool to select the geo-location on the map associated with the note and to add keywords, categories, or tags to facilitate sorting of the note. The user can choose to save the note as a draft or publish the note at any time.

### A Mobile Application Supporting an Example Embodiment

A mobile version of an example embodiment provides at user-friendly interface from which the user can easily view the relevant notes from a mobile device. As described in more detail below, a mobile software application (app) embodying a mobile version of an example embodiment as described herein can be installed and executed on a mobile device, such as a smart phone, laptop computer, or tablet device. In another embodiment, a website can be used without installing any software on the mobile device. In this embodiment, a user can use the features described herein Just by directing a browser to the website through the use of the preinstalled or installed browser. In an example embodiment, a splash screen appears whenever the user opens or launches the mobile application on the mobile device. This splash screen displays a host logo while opening the login screen or the live feed.

User log-in functionality in the mobile app provides a user-friendly user interface in which the user provides the email address and password associated with the user account. If the user does not have an account, the user can create an account from this user interface. The process of creating a user account is simple and only requires the user to provide the following information: name, surname, e-mail address, and password. By completing this information, the user can create an account and get access to news (e.g., notes) associated with the vicinity of the user's geographical location or any location that can be selected on the digital map.

### Mobile—Live

Mobile Live is a feed, which provides a list of news happening at the time (e.g., notes that are time-stamped with a date/time that is a configurable length of time in the recent past from the present date/time). The user can use the scrolling mechanism on the mobile device to browse for news that is proximate to the user's location. In an example embodiment, the provided search engine allows the user to perform a search for notes by keywords (e.g., terms used in the title, content, or meta data of the note that match a search query), or a search for a specific geographical location and cause the display of all notes associated with that geo-location. The header of the mobile application provides access to a News and Write tool icon, from which the user can create a note. In as notes list, each note appears with the image of the event associated with the note, the title and time in which the event occurred, as well as the location and level of accuracy associated with the note. A portion of the Mobile Live user interface provides a menu in which the user can change geo-location, search for notes using keywords, search for notes by category, configure filters, or change aspects of the user account settings.

### Mobile—Popular

The Popular tool of an example embodiment enables a user to filter and sort notes by popularity based on ratings provided by the community of users. In one embodiment, the user can only view the most popular notes. In other embodiments, the user can view the most popular notes and/or the least popular notes.

### Mobile—Veracity

The Veracity tool of an example embodiment enables a user to filter and sort notes by veracity based on veracity ratings provided by the community of users. The notes can be sorted by degree of accuracy (veracity), in order for the user to read notes that are more reliable. The Veracity tool can also be used to display only the notes the user or others have qualified as true. In one embodiment, the user can only view the most truthful notes. In other embodiments, the user can view the most truthful notes and/or the least truthful notes.

### Mobile—Notes

When the user selects a note, detailed information related to the note is displayed through a static display or via animation. When the user opens the note, the title of the note appears, the length of time the note has been published appears, and the geo-location associated with the note appears. The user can view a gallery of photos or other attachments associated with the note, first as a series of thumbnails from which the user can log in to view the attachments in full resolution. The user can view the number of comments associated with the note. The user can also view, edit, or add comments associated with the note by clicking on an icon associated with the note. The user has the option to rate the note as true or false. The user also has the option of reporting a note having inappropriate content.

### Mobile—Comments

The user can write a comment associated with a note by pressing the Write option to comment. The comment can be up to 4000 characters in an example embodiment. The comment appears as a popover adjacent to the note to which the comment relates. Comments can be ordered from the most recent to the first one that was generated for the note.

### Mobile—Map

The user can browse the map to find notes attached to specific points or geo-locations on the map. In an example embodiment, notes are represented on the map by an image of a blue pin or other icon or marker positioned at the geo-location on the map associated with the note. If there is more than one note associated with that geo-location, a number value indicating the quantity of notes associated with that geo-location is displayed. The user can zoom the map in or out. The map tool serves as a visual filter that allows the user to explore and find notes by geo-location.

### Mobile—Infobox

The Infobox is a preview of the note that is displayed when the user selects one blue pin on the map. In the example embodiment, the Infobox is displayed like a pin-shaped card which represents the image of the note. The preview of the note provided by the Infobox feature of the example embodiment also includes information indicative of the veracity of the note (e.g., whether the note is likely true or false based nit input from the community of users), the title of the note, and the time and location associated with the note. If the user wishes to know more about the note, the user can click a Read button to view the full contents of the note. If more than one note is placed at the same geolocation and at the same time such that one note overlaps another and the note icons are located in exactly the same position on the map at a very close time period, then the Infobox acts as a navigator to provide access to the notes that were placed in that area. The number of notes in that area can be shown over the Infobox. The user can slide to one side or another or click a button to be taken from one note to another. The user has the option then to see the preview of the notes and to decide which note she wants to read.

### Mobile—Search

In an example embodiment, the provided search engine allows the user to perform a search for notes by keywords (e.g., terms used in the title, content, or meta data of the note that match a search query), or a search for a specific geographical location and cause the display of all notes associated with that geo-location. Users can also filter or sort search results based on popularity and/or veracity. The search engine of the example embodiment responds in real time and yields relevant results.

### Mobile—Categories

The user can select from a list of categories to see only notes associated with their interests from specified categories.

### Mobile—Make a Note

The example embodiment provides an option to create a window where the user can complete the necessary information for the creation and publication of a note. The options include: add title and description of note; add or remove photos or other attachments; select a geo-location associated with the note; choose a category; and add keywords or tags.

### Mobile—Configuration

Using the configuration user interlace of the example embodiment, the user can set various system and operational parameters and view information about the terms and conditions of use and the privacy policy.

### Detail of an Example Embodiment

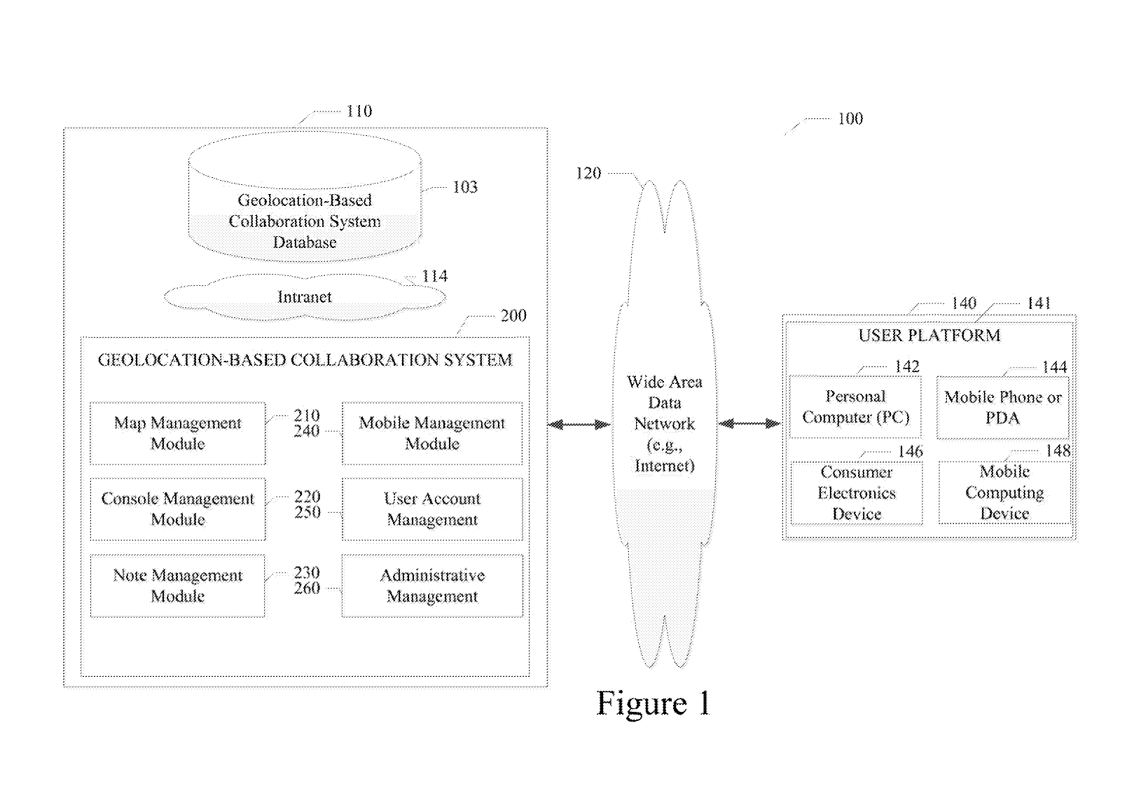

Referring now to FIG. 1, in an example embodiment, a system for geo-location based collaboration on a network-enabled interface is disclosed. In various example embodiments, an application or service, typically provided by or operating on a host site (e.g., as website) 110, is provided to simplify and facilitate the downloading or hosted use of the geo-location based collaboration system 200 of an example embodiment. In a particular embodiment, the geo-location based collaboration system 200 can be downloaded from the host site 110 by a user at a user platform 140. Alternatively, the geo-location based collaboration system 200 can be hosted by the host site 110 for a networked use at a user platform 140. The details of the geo-location based collaboration system 200 of an example embodiment are provided below.

Referring again to FIG. 1, the geo-location based collaboration system 200 can be in network communication with a plurality of user platforms 140. The host site 110 and user platforms 140 may communicate and transfer data and information in the data network ecosystem 100 shown in FIG. 1 via a wide area data network (e.g., the Internet) 120. Various components of the host site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless IAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The geo-location based collaboration system can be implemented using any form of network transportable digital data. The network transportable digital data can be transported in any of a group of file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interlace can be Extensible Markup language (XML). XML is a markup language that defines a set of rules for encoding interfaces or documents in a format that is both human-readable and machine-readable. In another embodiment, a JSON (JavaScript Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML.

In a particular embodiment, a user platform 140 with one or more client devices 141 enables a user to access data and provide data for the geo-location based collaboration system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., Twitter), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

As one option, the geo-location based collaboration system 200, or a portion thereof, can be downloaded to a user device 141 of user platform 140 and executed locally on a user device 141. The downloading of the geo-location based collaboration system 200 application (or a portion thereof) can be accomplished using conventional software downloading functionality. As a second option, the geo-location based collaboration system 200 can be hosted by the host site 110 and executed remotely, from the user's perspective, on host system 110. In one embodiment, the geo-location based collaboration system 200 can be implemented as a service in a service-oriented architecture (SOA) or in a Software-as-a-Service (SAAS) architecture. In any case, the functionality performed by the geo-location based collaboration system 200 is as described herein, whether the application is executed locally or remotely, relative to the user.

Referring again to FIG. 1, the geo-location based collaboration system 200 of an example embodiment is shown to include a geo-location based collaboration system database 103. The database 103 is used in an example embodiment fir data storage of information related to the geographical location of users, the geo-location associated with notes, communications between community members, shared documents, photos, or communication sharing information, the users involved in the social interactions, and the control data for managing the social interactions and the associated user interfaces. It will be apparent to those of ordinary skill in the art that the database 103 can be used for the storage of a variety of data in support of the geo-location based collaboration system 200 of an example embodiment.

Referring again to FIG. 1, host site 110 of an example embodiment is shown to include a geo-location based collaboration system 200. Geo-location based collaboration system 200 can include a map management module 210, a console management module 220, a note management module 230, a mobile management module 240, a user account management module 250, and an administrative management module 260. Each of these modules can be implemented as software components executing within an executable environment of geo-location based collaboration system 200 operating on host site 110 or user platform 140. Each of these modules of an example embodiment is described in more detail below in connection with the figures provided herein.

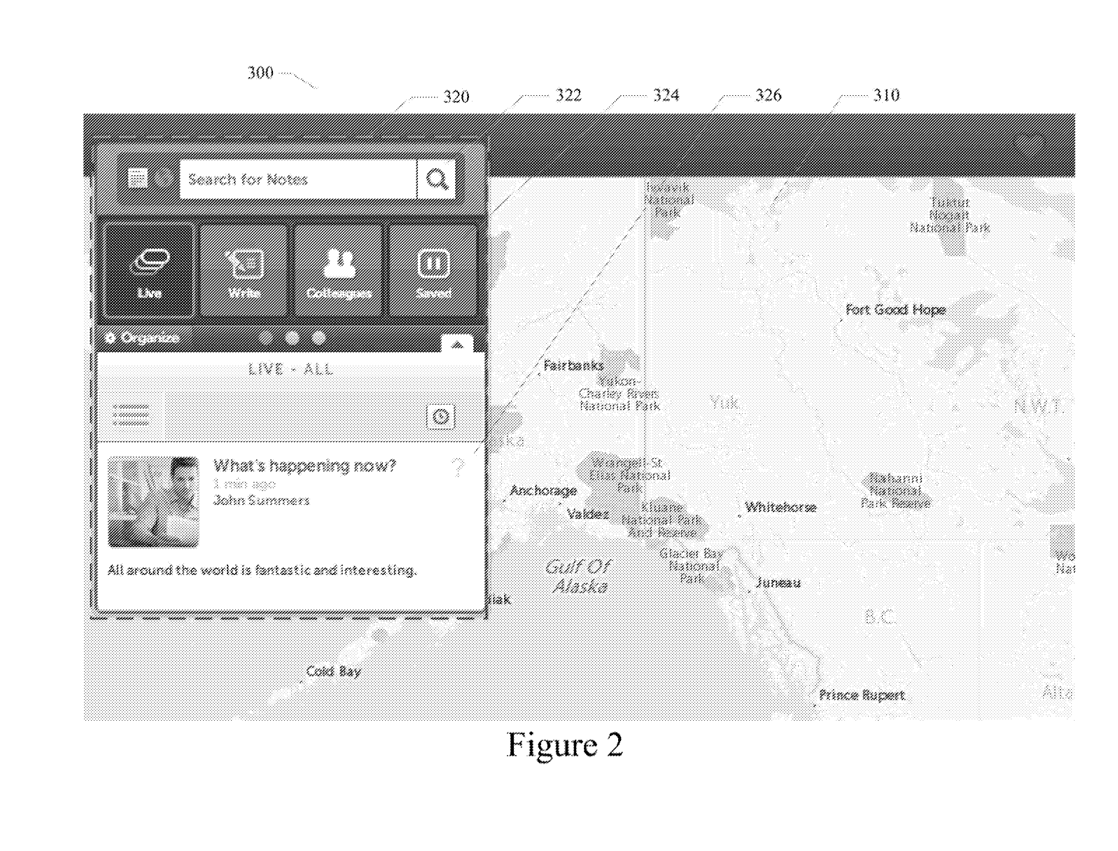

Referring still to FIG. 1, the geo-location based collaboration system 200 of an example embodiment can include a map management module 210. As part of the user interface, the functionality of an example embodiment provides two basic elements: 1) a geographical map and, 2) a console or user platform with a user interface from which the user can access the various tools provided by the site or the application. Referring now to FIG. 2, an example user interface snapshot 300, implemented as a web app, illustrates the basic elements of the user interface. As shown, the user interface includes a map 310 and a console 320 (enclosed in a dashed rectangle for clarity). The details of console 320 are described in more detail below.

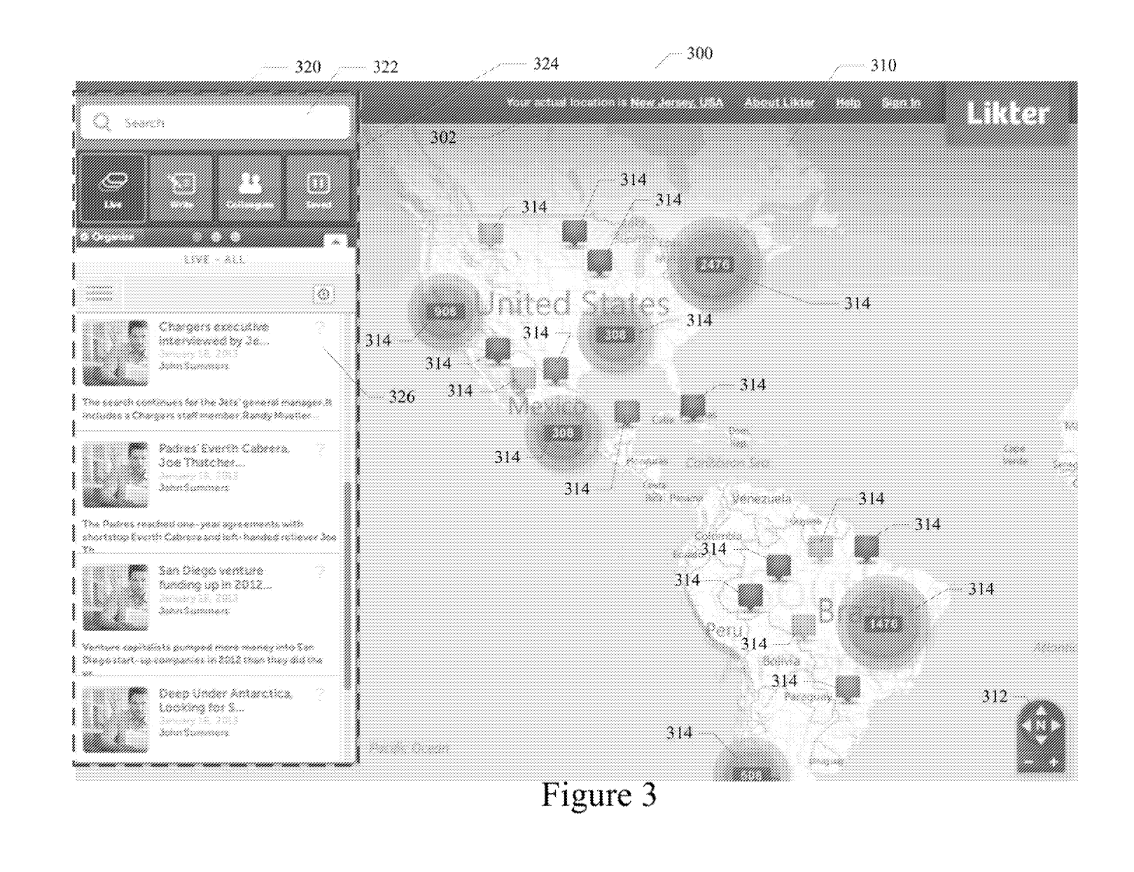

Referring now to FIG. 3, another example user interlace snapshot, implemented as a web app, illustrates the map 310 and console 320. In an example embodiment, the geographical map 310 acts as a filter that allows the user to see the notes or other content relevant to their geographical location or a selected geo-location. The map of a particular default location can be declared by the user when setting up their account. The default location can be modified using a profile tool. As described above, the particular default geo-location for the user can be declared by the user when setting up their account. Alternatively, the default geo-location for the user can be obtained through the user's browser or automatically obtained using other well-known techniques. In an example embodiment, the user can scroll the map and zoom in and out using a navigation tool 312 located in the lower right corner of a display screen of the user platform. The map shows detailed information about the selected location. The user can also see icons 314 on the map that indicate the sites (geo-locations) where a user has created a note or geo-locations associated with particular notes. When the user selects (e.g., clicks on) a note on the map, the user can see a preview of the note with the title of the note, an indication of related notes, and an indication of the type of content of the note that may include text, links, images, video, audio, executable code, interpretable code, other types of content, and/or a combination thereof. If the user wants to see the complete note, the user merely selects (e.g., clicks on the title of the note and the complete content of the note is viewable. The user can browse the map to find notes attached to specific points or geo-locations on the map. In an example embodiment, notes are represented on the map by an image of a blue pin or blue circle (or other type of icon or marker) positioned at the geo-location on the map associated with the note. If there is more than one note associated with that geo-location or an area within a pre-determined distance from that geo-location, a number value indicating the quantity of notes associated with that geo-location is displayed. The user can zoom the map in or out using the navigation tool 312. The map tool serves as a visual filter that allows the user to explore and find notes by geo-location.

Referring to FIG. 1, the geo-location based collaboration system 200 of an example embodiment can include a console management module 220. The console of an example embodiment can be implemented as a user interface on a user platform. The various types of user platforms are described in more detail above. Referring again to FIGS. 2 and 3, an example user interface snapshot, implemented as a web app, illustrates the basic elements of the console. The console of an example embodiment is made up of three parts: a search engine 322, a toolbar (Toolbar) 324, and a portion or region of the user interface in which information is displayed according to a user selected tool 326. The search engine 322 allows the user to perform a search for notes by keywords, or a search for a specific geographical location and to cause the display of all notes associated with that geo-location. The toolbar (Toolbar) 324 shows four tool icons at all times of the nine tools available to users in the example embodiment. The user can arrange the order in which the tool icons appear in toolbar 324. The user can also manipulate a slidebar to display the remaining tool icons in toolbar 324.

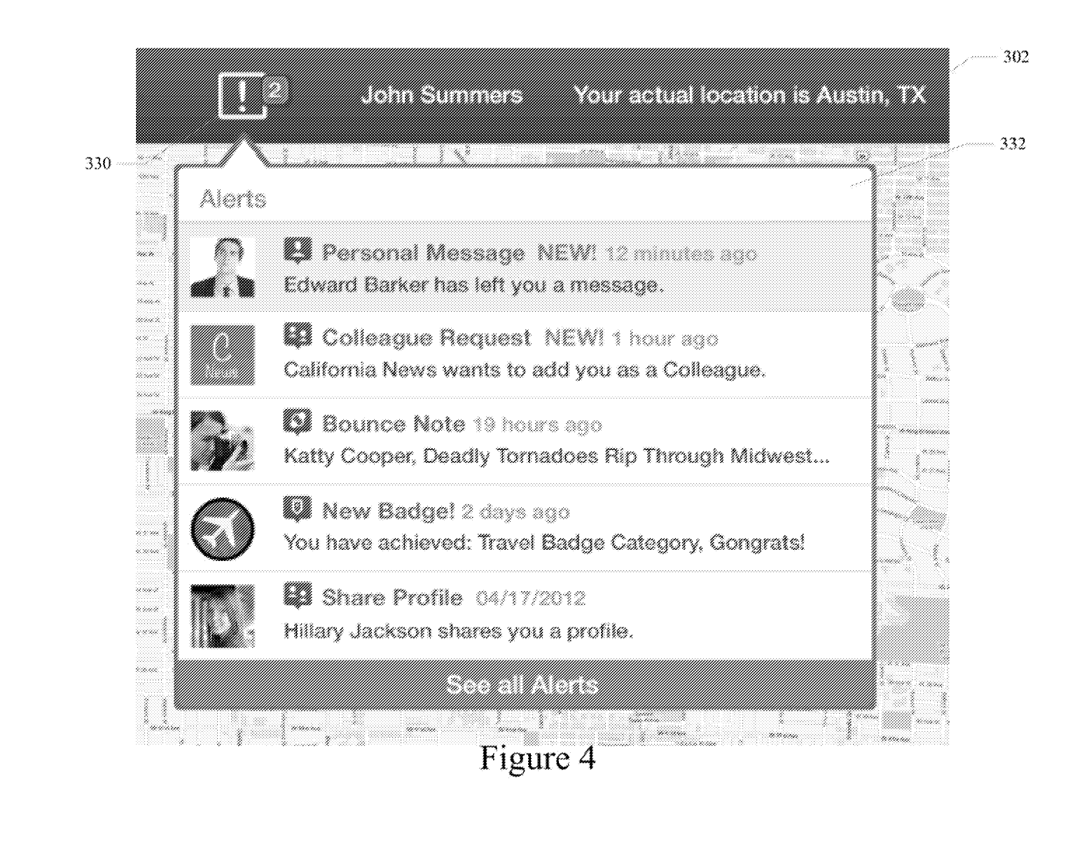

Referring now to FIG. 4, the Alerts tool 330 of an example embodiment works as a notification center, which can be used to show a user the notes that have been recommended to the user by another user (e.g., a colleague) using the Bounce function described in more detail below. The recommended notes are displayed to the user as a list of notes in an alert display area 332 as shown in FIG. 4.

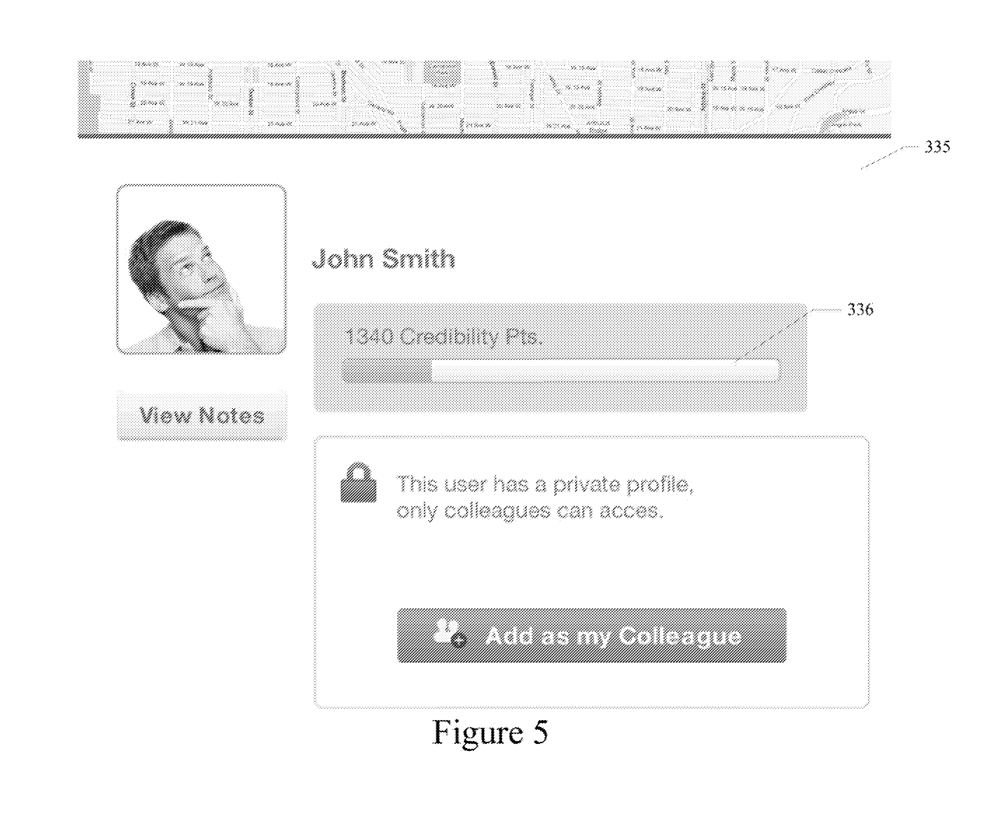

Referring now to FIG. 5, the Colleagues tool 335 of an example embodiment enables a user to manage a contact list or address book in an example embodiment. A user can use the Colleagues tool 335 to find and add new contacts by name and location. The toolbar 324 can include a tool icon corresponding to the Colleagues tool 335, which can be activated to enable the use of the Colleagues tool 335. As also shown in FIG. 5, a credibility indicator 336 can be associated with each user. The credibility indicator 336 provides an indication of the user's credibility based on the aggregated rating of the user provided by other users.

Referring again to FIGS. 2 and 3, the toolbar 324 can include a tool icon corresponding to as Filter tool. The Filter tool of an example embodiment enables a user to create filters that apply certain conditions to manage the notes that appear to the user. The user can name each filter and establish filtering criteria that specify limiting conditions to enable the embodiment to select only particular notes that meet the specified limiting conditions. These filtering criteria can include: select only notes that contain certain keywords selected by the user; select only notes issued by one or more of the user-defined colleagues; select only notes associated with a particular geographical area; or the like. It will be apparent to those of ordinary skill in the art that a variety of other filtering criteria can equivalently be used. In one embodiment, a tool denoted Look-Out is provided. Using this tool, a user can predetermine certain criteria that he/she considers to be of interest. For example, a user can use this tool to select an area on the map and thereby enable the application to send notifications to the user whenever a note that includes any of a set of pre-selected words or categories is posted by any other user inside the preselected geographical area.

Referring again to FIGS. 2 and 3, the toolbar 324 can include a tool icon corresponding to a Live tool. The Live tool of an example embodiment enables a user to view a live feed of notes that represents the most recent notes corresponding to a portion of the map that is visible on the display screen at the time. In various embodiments, the notes made viewable by the Live tool can be filtered based on user preferences and the active filters configured with the Filter tool. The user can select how often to refresh the list of most recent notes from ten seconds to a minute. As shown in FIGS. 2 and 3, the list of notes in region 326 can include the note author's name, a picture of the note's author, the title of the note, the age of the note, the level of reliability (veracity) of the note, and the first words of the textual content of the note. If the user moves the cursor (or other well-known pointing device) over one of the notes in the feed, a set of options are automatically displayed to enable the user to qualify the note as true or false, save the note to read later, or share the note using the Bounce function. If the user decides to share the note, a small window is opened to allow the user to select the colleagues with whom the note is shared.

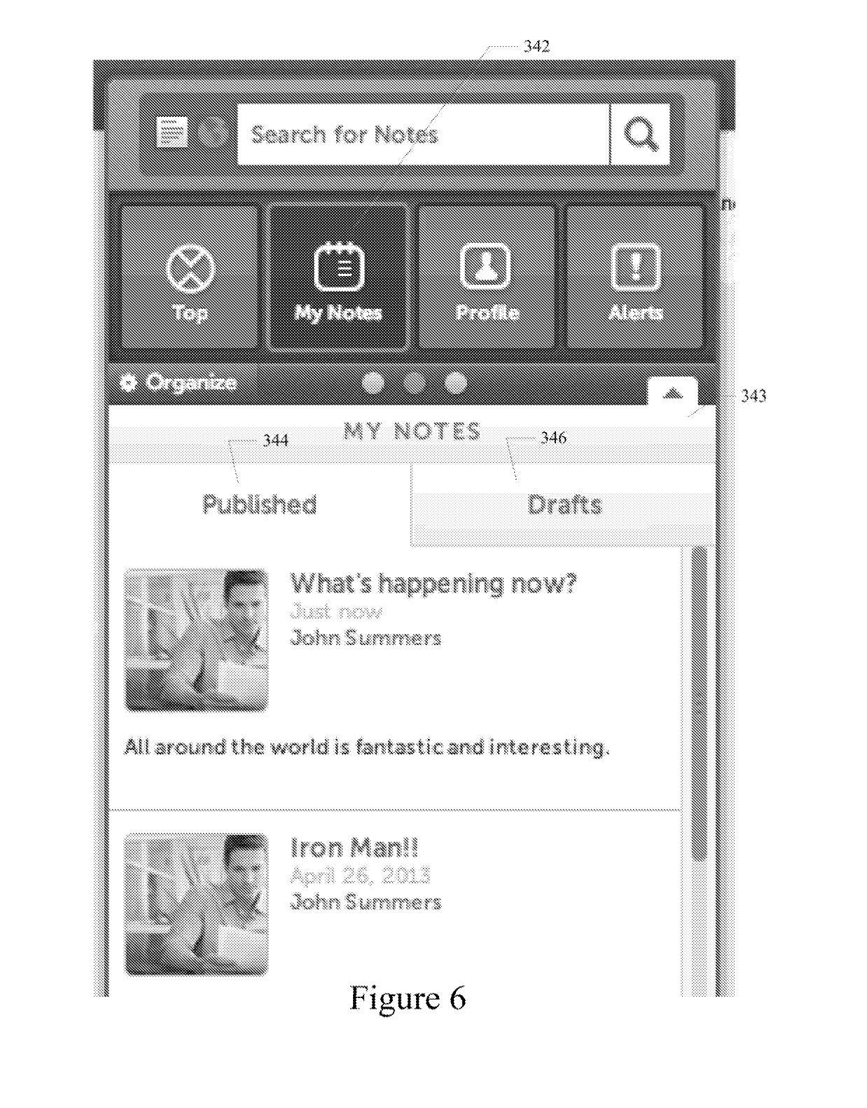

Referring now to FIG. 6, the My Notes tool 342 of an example embodiment enables a user to archive all of the notes written by the user. The user interface 343 of the My Notes tool of an example embodiment is divided into two tabs. Published 344 and Drafts 346. The Published tab 344 displays all published notes of the user; the Drafts tab 346 displays all un-published notes of the user. In an example embodiment, a Saved tool enables a user to save notes, view saved notes, and manage saved notes. A Top tool of an example embodiment enables a user to cause the display of relevant notes by geographical location or by search criteria. The user can also sort notes by level of veracity or popularity.

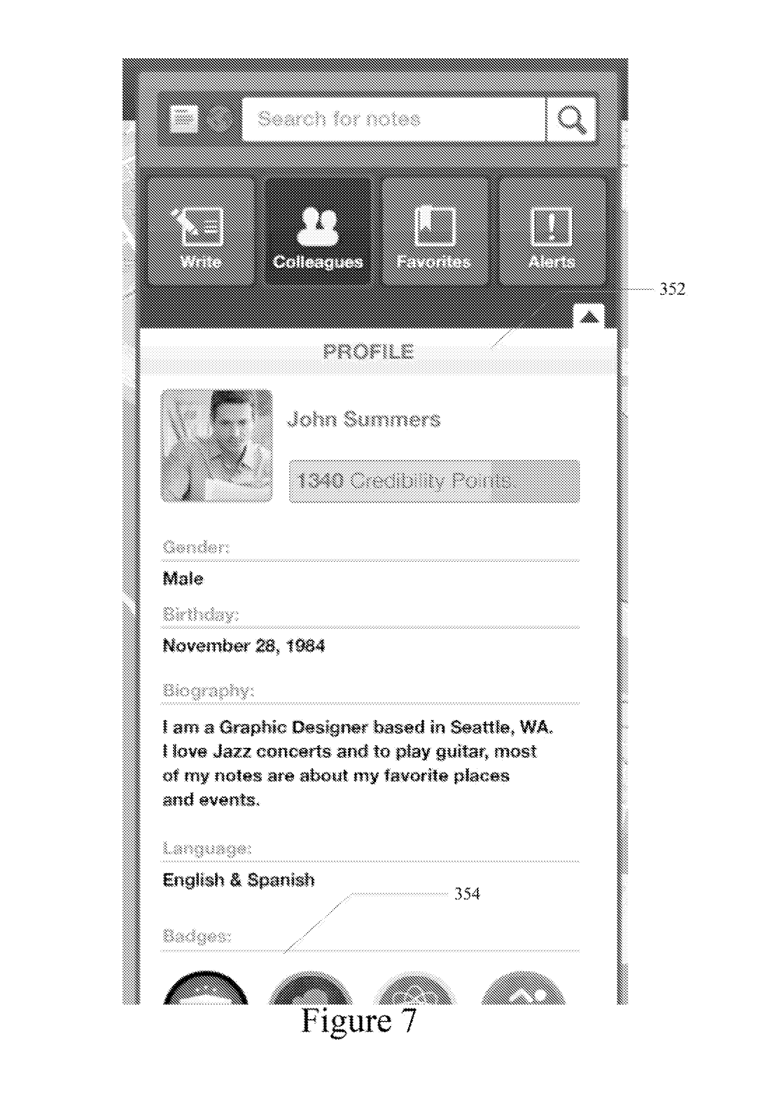

Referring now to FIG. 7, the Profile tool 352 of an example embodiment enables a user to edit their profile information. The user can use the Profile tool 352 to, for example, change the picture that identifies the user in the user's notes. The Profile tool 352 can also be used to configure the ability of the social community to view the user's credibility points, which are obtained for participation on the site. The Profile tool 352 can also be used to configure Badges 354, which are recognitions for good performance on the site. The Profile tool 352 can also be used to configure the email address associated with the account, password, name, date of birth, language, default geographical location, and user biographical or configuration information.

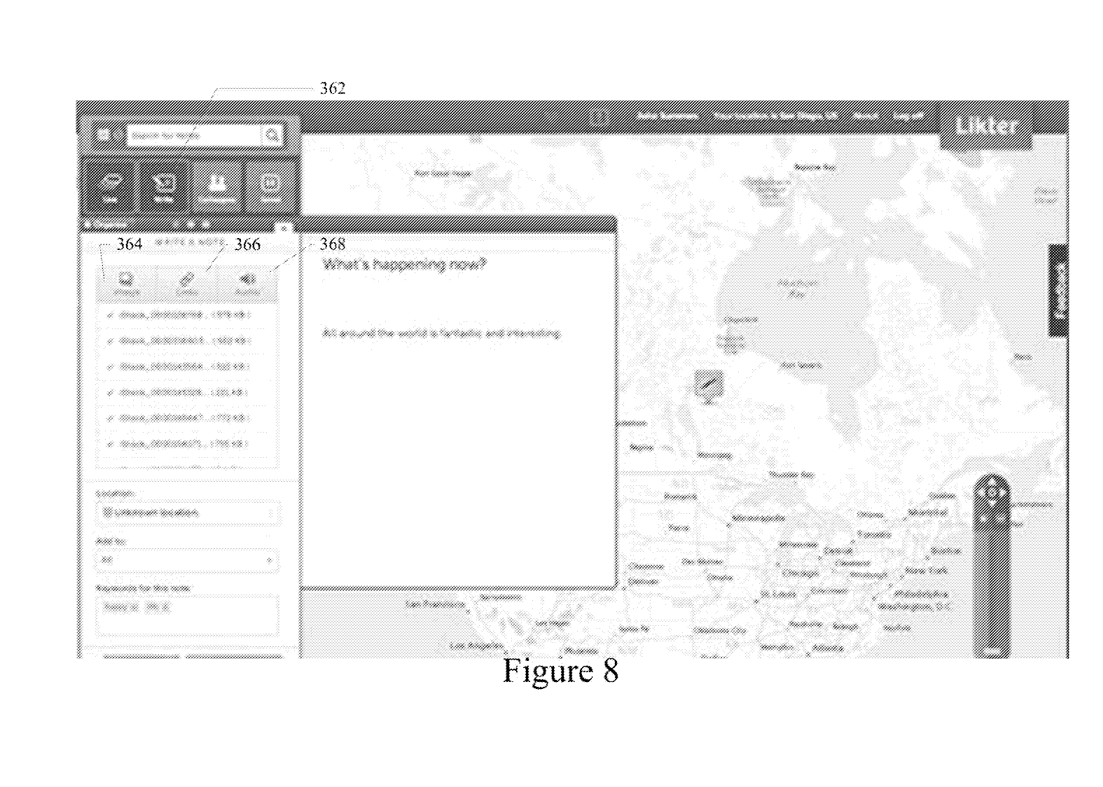

Referring now to FIG. 8, the Write tool 362 of an example embodiment enables a user to create notes. The user can use the Write tool 362 to add or edit the text of a note and add other content, such as images (using tool 364), hyperlinks (using tool 366), video or audio (using tool 368), and the like. The user can also use the Write tool 362 to select the geo-location associated with the note on the map and to add keywords or tags to facilitate sorting of the note. The user can choose to save the note as a draft or publish the note at any time.

Referring again to FIGS. 3 and 4, the menu bar 302 of an example embodiment is visible at all times and has the following elements: an icon in the form of a heart, the Alerts tool icon 330, the user name of the account in use, the geographical location associated with the account in use, an About section, and the function enabling the user to log in The heart-shaped icon (see FIG. 2) opens a window or other user interface display region from which the user can make a donation from $1 USD to $100 USD via PayPal™ or Google™ Wallet. The Alerts tool icon 330 opens a display with all user notifications as described above. The user name of the account in use identifies the name of the user account currently in use or associated with the current user.

Referring again to FIG. 1 and FIGS. 9 through 19, the geo-location based collaboration system 200 of an example embodiment can include a note management module 230. The core of the user experience in the geo-location based collaboration system of an example embodiment is focused on the generation, searching, filtering, and viewing of notes. In various embodiments, a note is a user-generated compilation of information and/or content that may include text, links, images, video, audio, executable code, interpretable code, other types of content, and/or a combination thereof. In an example embodiment, notes are generated by users. Each note can be associated with a geographical location and an associated icon or other marking associated with the note may be located geographically on the map. The functionality of the example embodiment provides several ways to view this note content. For example, the notes are accessible from the map 310 or from the console 320. On the map 310, the geographical location associated with the note can correspond to a geo-location where an event occurred that is related to the note. The geographical location associated with the note can also correspond to a geo-location of the note's author or a location set by the author. Using the map 310, a user can click on an icon or other marking associated with the note and get access to the content of the note. Using the console 320, the user can search for notes using a content query, filter notes, rate the veracity of notes, obtain access to notes via a recommendation from others, or obtain access to notes through the Live feed tool described above.

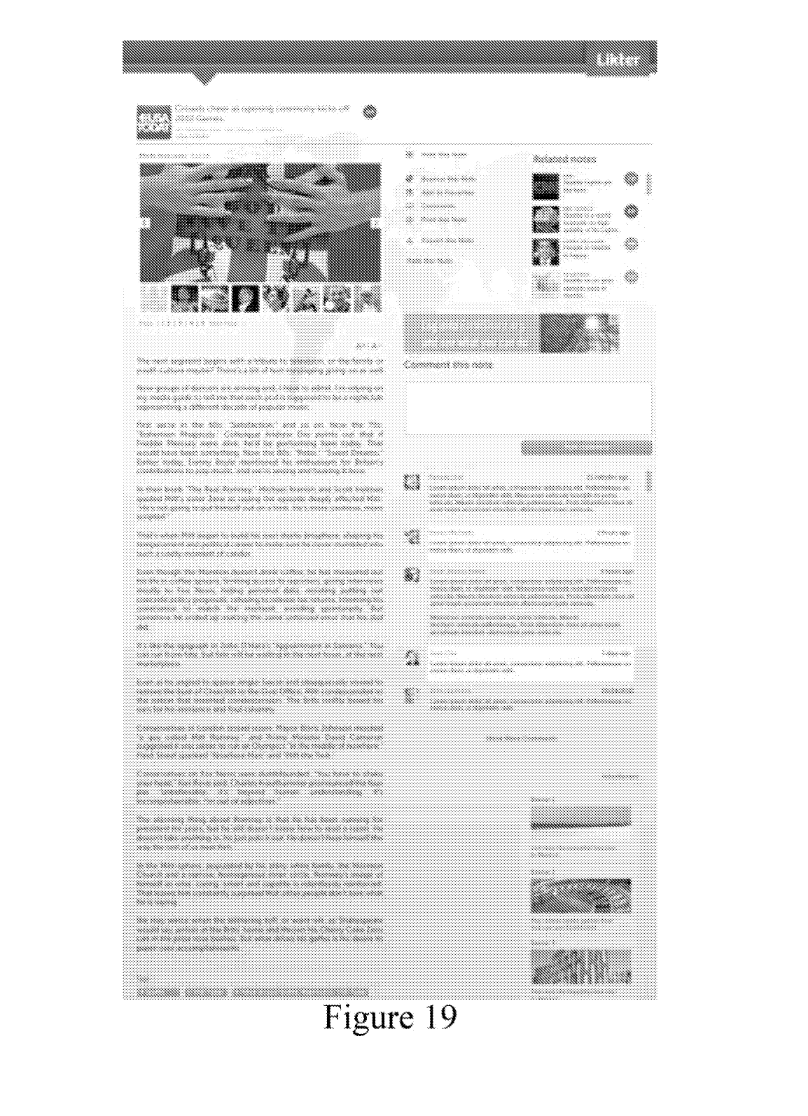

By deploying or obtaining a note, a user has several ways to interact with the content of the note. For example, in the header of the note, the header includes the picture of the user who created the note, the title of the note, the user name of the user who created the note, and the age or time/date associated with the note. Below the content of the note, the note includes labels, tags, captions, or other meta data, which can be used to classify, categorize, or filter the note for more efficient searching and storage. An example embodiment enables a user to view a note and to manipulate or interact with a note in a variety of ways, including: adding comments to a note, opening the note in a new browser tab, saving the note to read later, sharing the note with friends by using the Bounce feature of the example embodiment, reporting the note to a host authority as containing inappropriate content, and recording the user's opinion as to the degree of accuracy or veracity of the note (e.g., the note is false (Fake button) or the note is true (True button)). In an example embodiment, the note interaction options appear in a lateral stripe, which also displays a list of related notes. In the case of opening the note in a separate tab, as described below in connection with FIG. 19, an example embodiment adds the ability to print the note (e.g., Print this note). In an example embodiment, the notes can be classified into the following predefined categories: Arts and Culture, Business, Entertainment, Food, Health, Opinion, Politics, Public Safety, Science and Nature, Sports, Technology, Travel, Weather. It will be apparent to those of ordinary skill in the art that a variety of other categories can equivalently be used. In the example embodiment, the user can also view the note publisher's profile and add him/her as a colleague, depending on the publisher's privacy settings.

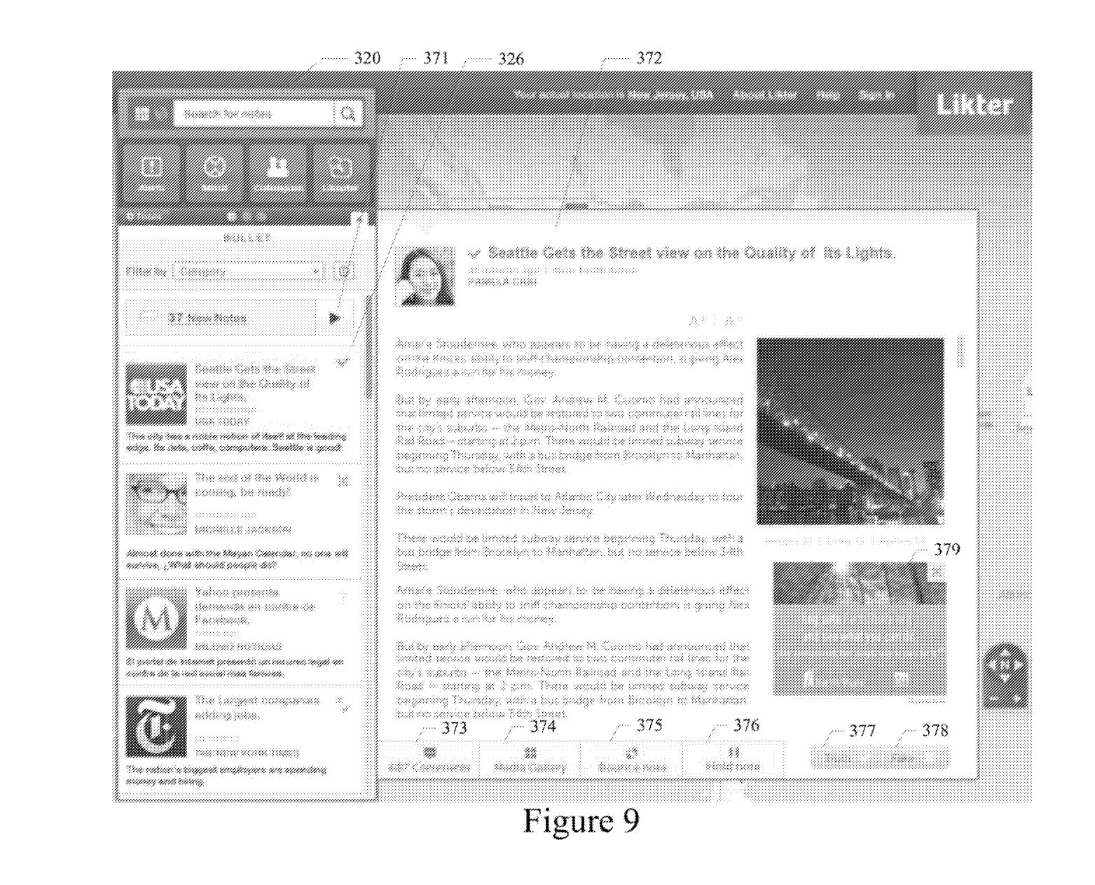

Referring now to FIG. 9, an example user interface snapshot, implemented as a web app, illustrates the basic elements of the user interface for viewing and manipulating notes. As illustrated in FIG. 9, the sample screenshot shows as live feed of note summaries or note headers in region 326 of the console 320 with an open note shown in a note detail window 372 displayed adjacent to the console 320. The user can click on any of the note headers in region 326 to display the detail of a selected note in the note detail window 372. Inside the note detail window 372, the note management module 230 displays the content of the selected note and presents several note tools for manipulating the note. In an example embodiment, these note tools include: Comments 373, Media Gallery 374, Bounce Note 375, Hold Note 376, Voting Truth 377, or Voting Fake 378. These note tools are described in more detail below. Additionally, an advertisement (ad) 379 can be displayed in note detail window 372. The ads displayed in the note detail window 372 can be obtained from a conventional ad server using well-known techniques. The ads served can be customized based on the content of the note in which the ads are displayed or customized based on a user profile or learned user behavior of the user to whom the ads are being shown. The live feed of note summaries or note headers in region 326 of the console 320 can be suspended while a note detail is displayed in note detail window 372. The Play button 371 restarts the process of receiving new posted notes of the live feed in region 326 of the console 320.

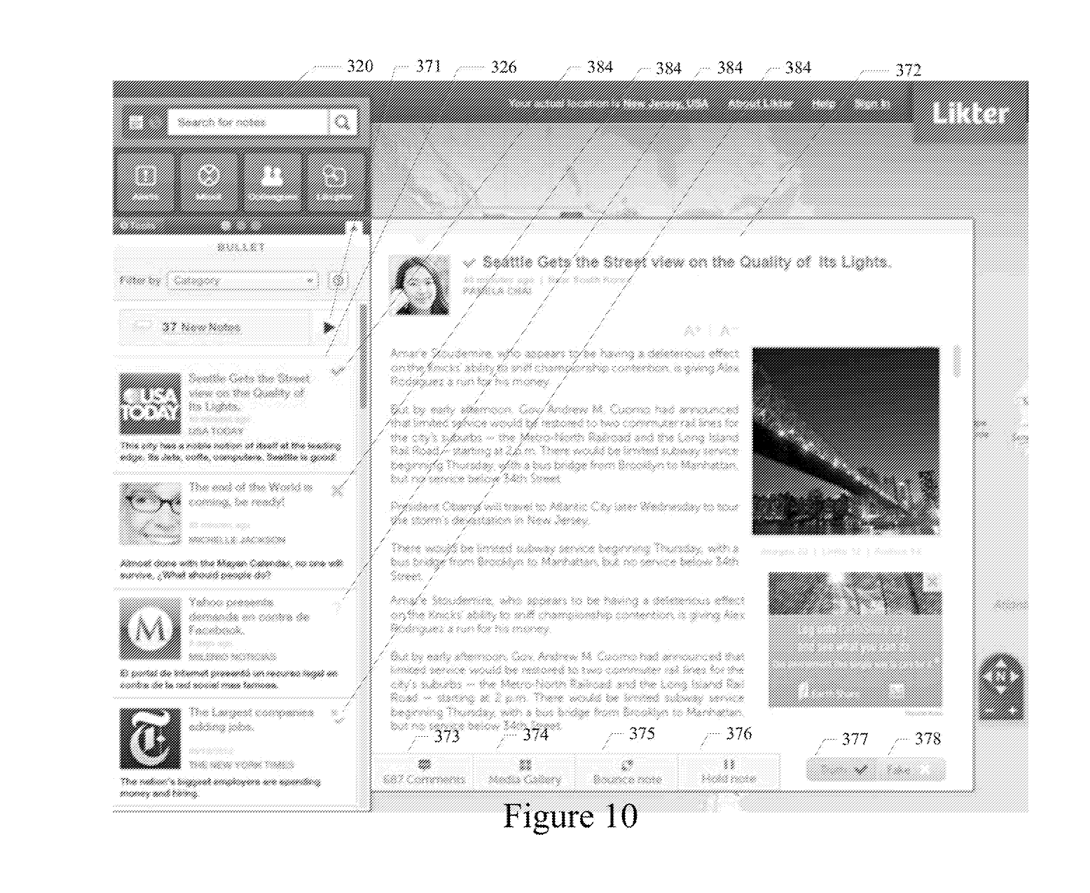

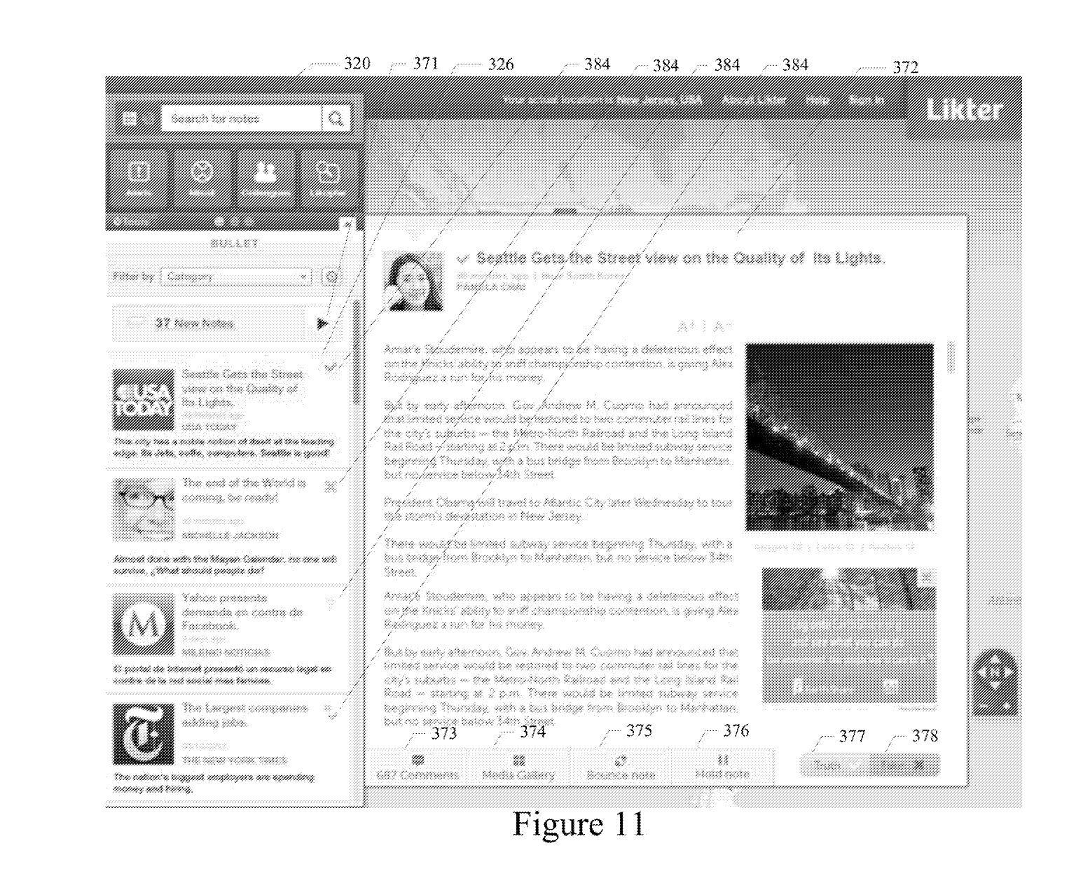

Referring now to FIGS. 10 and 11, an example user interface snapshot, implemented as a web app, illustrates the voting features of the user interface for submitting a vote related to a note. In the various embodiments as described above, the map acts like a filter. Notes in a live feed are received from all around the globe. As illustrated in FIGS. 10 and 11, the sample screens hot shows how a user can view one of the notes front the feed in the note detail window 372 and submit a vote related to the viewed note by use of the Truth button 377 or the Fake button 378. In the example shown in FIG. 10, the user has clicked on the Truth button 377 to indicate his/her belief that the content of the note in the note detail window 372 is likely true, valid, or credible. In the example shown in FIG. 11, the user has clicked on the Fake button 378 to indicate his/her belief that the content of the note in the note detail window 372 is likely false, invalid, or not credible. As also shown in FIGS. 10 and 11, the note summaries or note headers in region 326 of the console 320 include a veracity indicator 384 next to each note title.

The veracity indicator 384 represents an aggregation of the votes submitted by other users in relation to a particular note. In a particular embodiment, the vote of each user can have a different value that is determined by his/her proximity to the event or geolocation associated with the note for which the vote is being recorded. The location of the voter can be acquired by the application, if possible, using well-known techniques. If the location of the voter cannot be acquired, the value of the vote from the non-geo-located voter is less than what it could be if the voter had an obtainable geo-location. In general, the closer a veracity voter is to the location corresponding to the note based on geo-location, the greater the value of the corresponding vote will be. As a result, an example embodiment can weight the voting of notes based on the geo-location of the voters. In the example embodiment, every note has a voting span of 24 hours for other time period). This means that users can only vote on a note during the first 24 hours of the note's publication. After that time span has expired, the voting process is closed for that specific note. In the example embodiment, there are four possible states represented by the veracity indicator 384 as distinctive icons: 1) a green check mark icon to indicate that a majority of voting users submitted a vote indicating the content of the particular note is likely true, valid, or credible; 2) a red X icon to indicate that a majority of voting users submitted a vote indicating the content of the particular note is likely false, invalid, or not credible; 3) an interrogation sign or question mark “?” icon to indicate that a quorum of voting users has not yet occurred; and 4) a small red X icon in combination with a small green cheek mark icon to indicate that the aggregated votes are equivalently true and false and thus, it cannot yet be determined if the particular note is likely true or fake.

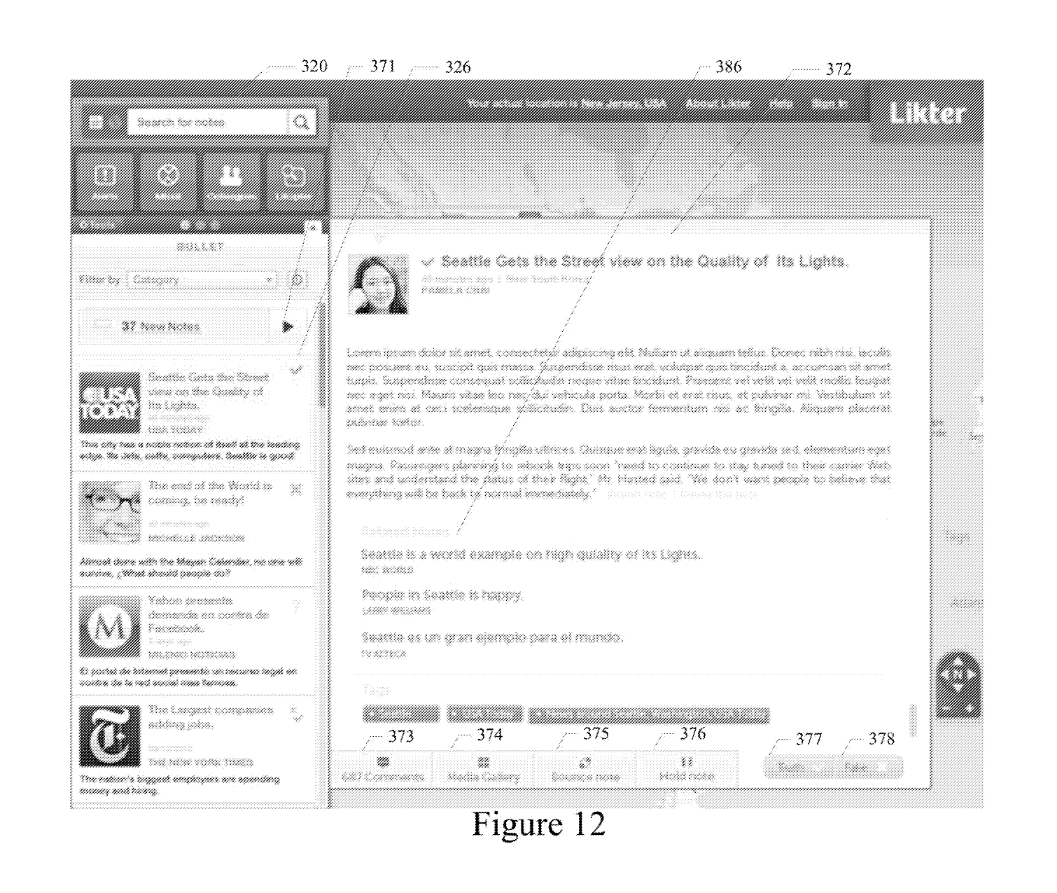

Referring now to FIG. 12, an example user interface snapshot, implemented as a web app, illustrates additional elements of the user interface for viewing and manipulating notes. As illustrated in FIG. 12, the sample screenshot shows the content of a sample note in the note detail window 372. As additionally displayed under the sample note, a set of related note titles and tags 386 can also be displayed. The related note titles and tags 386 identify other notes that are related to the sample note in some characteristic or dimension, such as common geo locations, common keywords, common author, common date/time, common category, use of common images, use of common video or audio clips, or the like. Additionally, tags that were placed by the author of the note can be displayed to make it easier to find related notes in a note database.

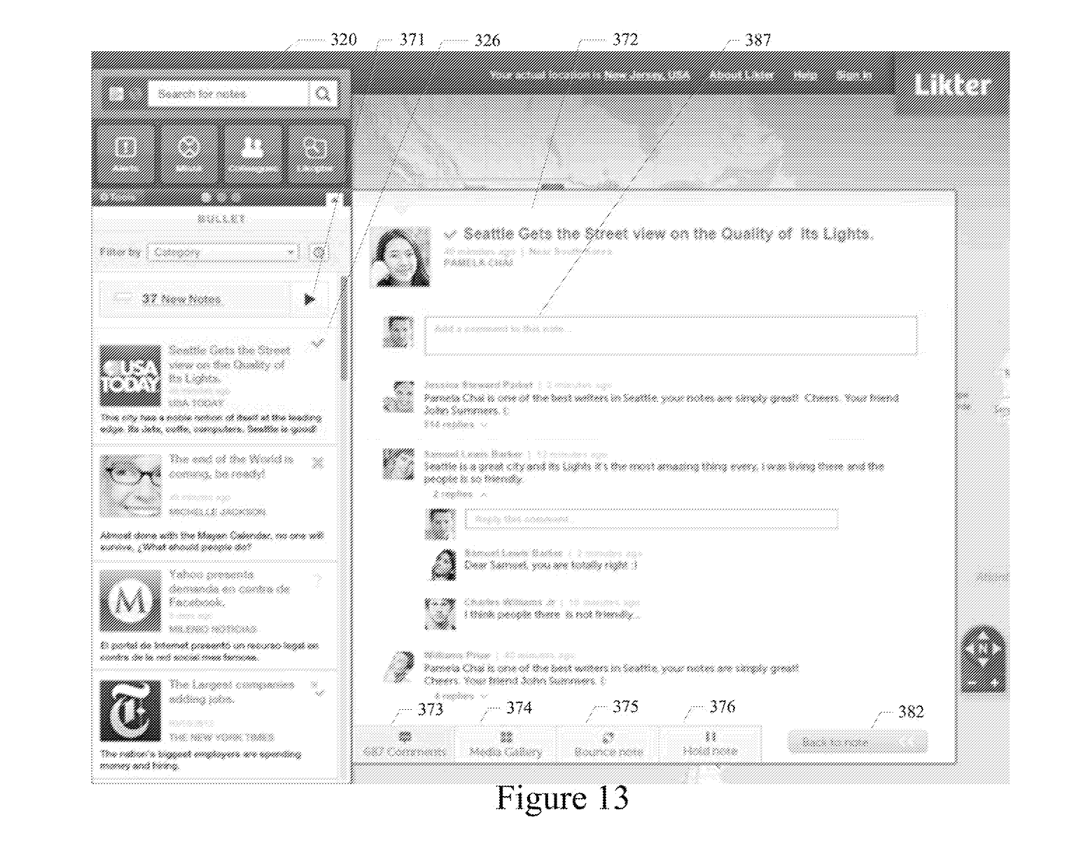

Referring now to FIG. 13, an example user interface snapshot, implemented as a web app, illustrates additional elements of the user interface for viewing and manipulating notes. As illustrated in FIG. 13, the sample screenshot shows how the content of a sample note can be shown in the note detail window 372. As additionally displayed in relation to the sample note, a comment area 387 can also be displayed. The comment area 387 enables other users to add comments related to the sample note and allows other users to see comments added by the other users. Also, a button 382 is provided to toggle between a view of the content of the sample note and a view of the comments related to the sample note.

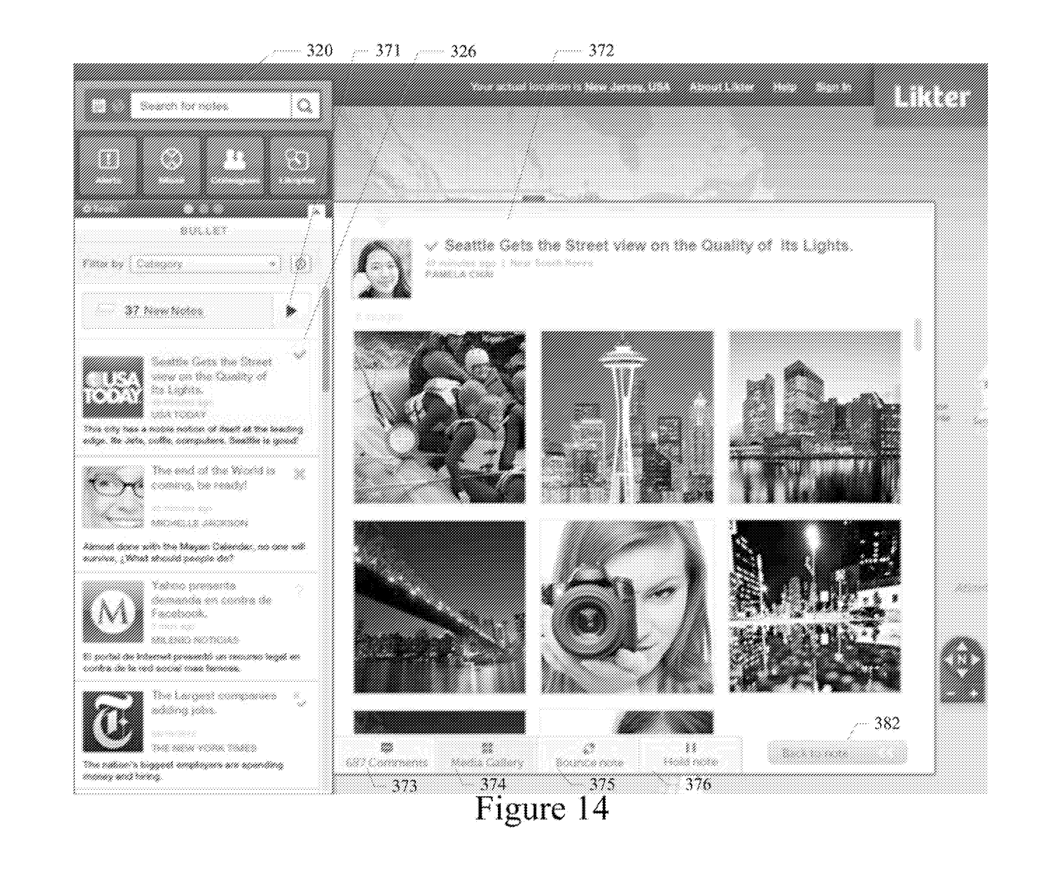

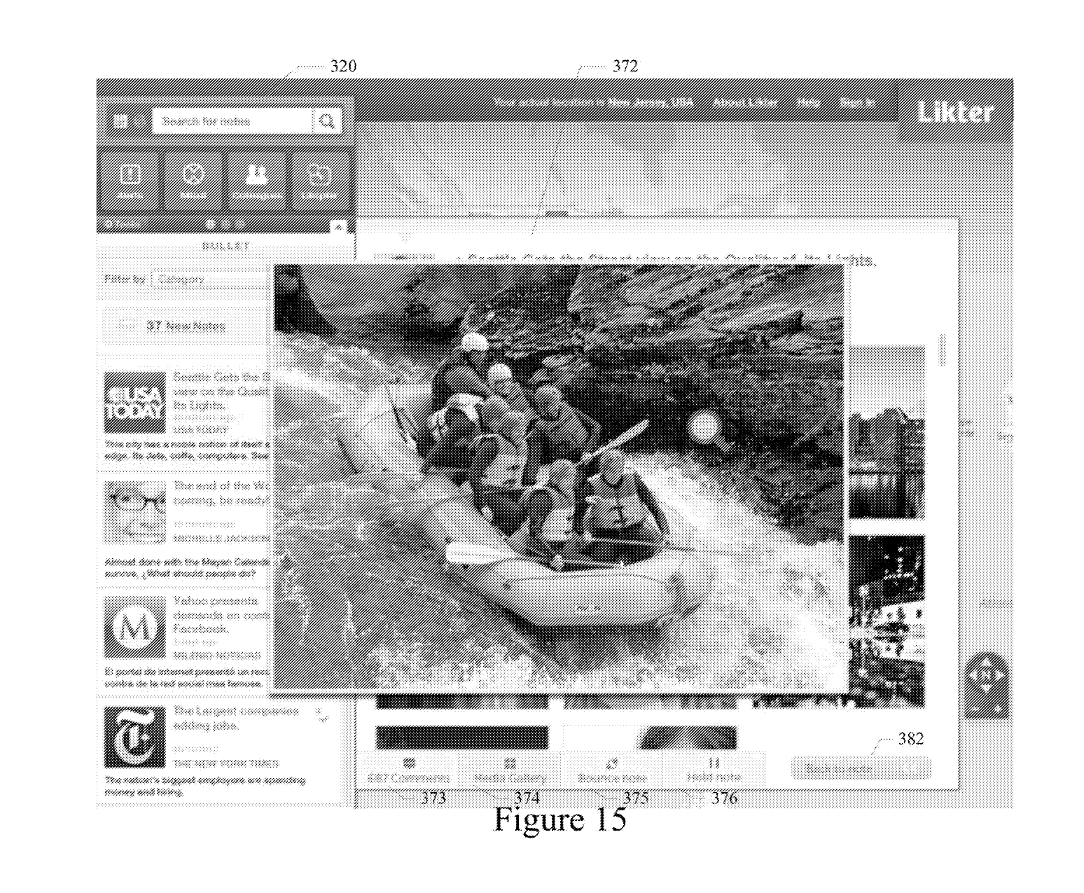

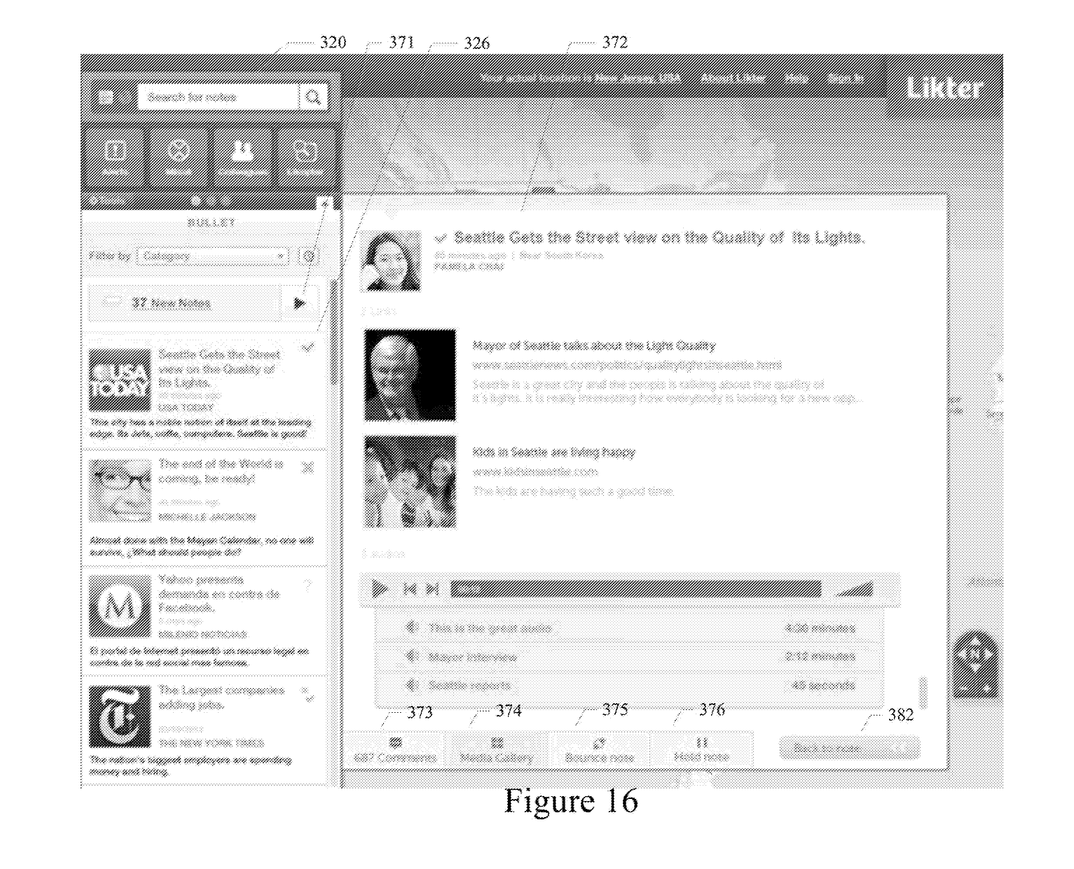

Referring now to FIG. 14, an example user interface snapshot, implemented as a web app, illustrates additional elements of the user interface for viewing and manipulating notes. As illustrated in FIG. 14, the sample screenshot shows how the content of a sample note can be shown in the note detail window 372. Media Gallery 374, in an example embodiment, allows the user to view a gallery of photos uploaded by users, wherein the photos relate to notes that are all connected to a particular event, place, or time space. In one embodiment, the media gallery can be divided into two different parts; the media gallery for a note; and the mosaic or compendium of images from different notes that are closely related to a particular subject, time, and/or geographical area. Media Gallery 374, of an example embodiment, provides a way to connect in a mosaic the notes that are related in one or more dimensions, including common titles, content, tags, time, geo-location, author, veracity, popularity, and the like. In the example shown in FIG. 14, the author of the sample note has uploaded a set of pictures attached to the sample note. These images attached to the note can be viewed by clicking on the Media Gallery button 374. The images are displayed in the note detail window 372. Then, by clicking on a particular image, each picture is individually viewable as shown in FIG. 15. In a similar manner, other types of attachments, such as documents, video clips, audio clips, executable code, interpretable code, and the like can also be added to a note and viewed, rendered, and/or executed by other users. For example, FIG. 16 illustrates a sample screenshot showing a user listening to an audio file that was uploaded by the author of the note. The note author also added links that are related to the content of the note. These links are displayed in the example of FIG. 16. These links can be activated by a receiver of the note to get access to additional content associated with the note. Also, a button 382 is provided to toggle between a view of the content of the sample note and a view of the attachments related to the sample note.

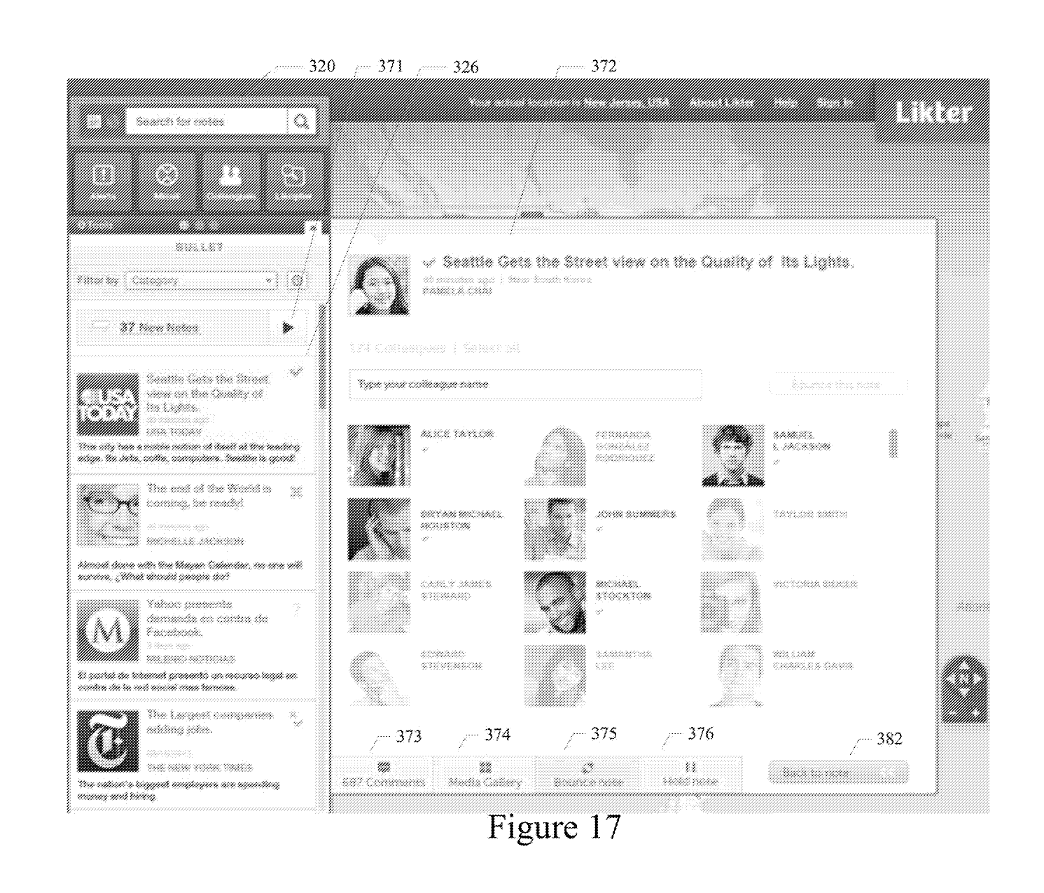

Referring now to FIG. 17, an example user interface snapshot, implemented as a web app, illustrates additional elements of the user interface for viewing and manipulating notes. As illustrated in FIG. 17, the sample screenshot shows how the content of a sample note can be shown in the note detail window 372. In this example, the user is selecting a few colleagues from an address book or contact list. Using the bounce button 375, the user can send a copy of the sample note (bounce the note to the colleagues selected from the address book or contact list. This function allows for users to send notes that might be of interest to others so they can read them while on the website. The user receiving a bounced note is alerted to the received note via an alert indicator 330 and the presence of the bounced note in an alert display area 332 as shown in FIG. 4. Also, a button 382, shown in FIG. 17, is provided to toggle between a view of the content of the sample note and a view of the address book or contact list

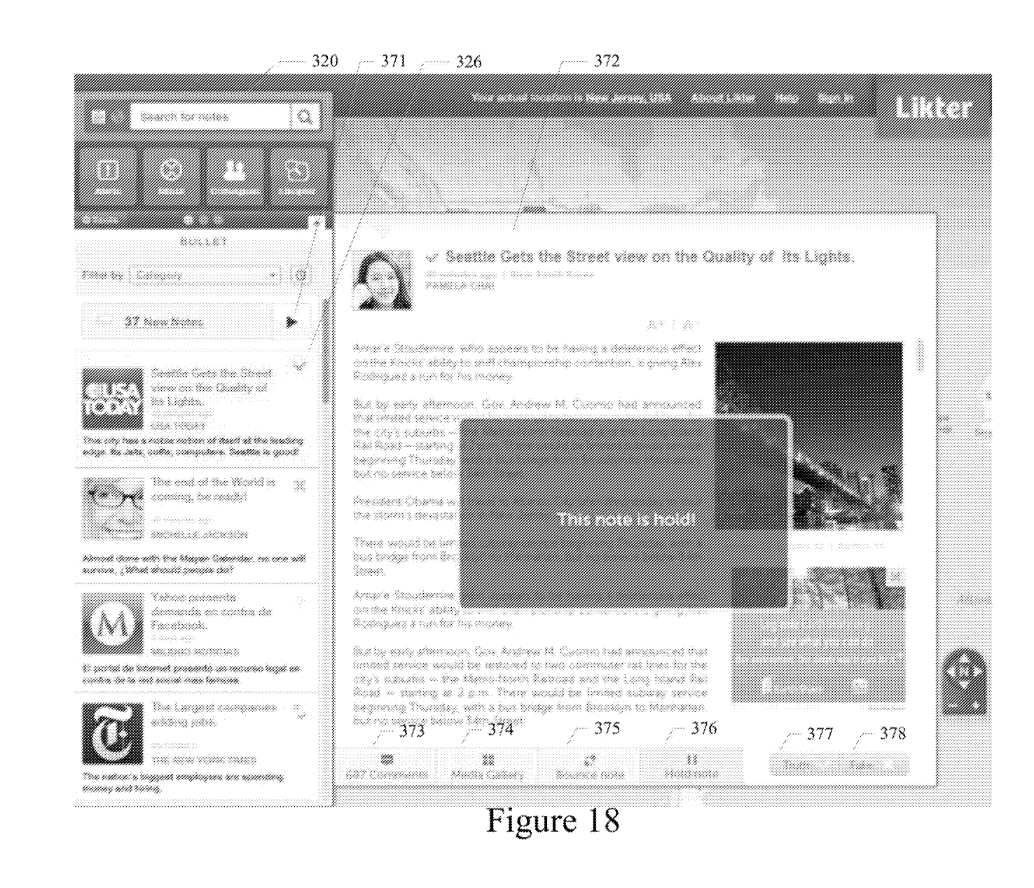

Referring now to FIG. 18, an example user interface snapshot, implemented as a web app, illustrates additional elements of the user interface for viewing and manipulating notes. As illustrated in FIG. 18, the sample screenshot shows how the content of a sample note can be shown in the note detail window 372. In this example, when navigating through the site, there might be notes that are too long to view in the time available, but are interesting enough to read. In some cases, the user does not have time at that specific moment to read the note. In this case, the user can click on the Hold Note button 376 shown in FIG. 18 so that the note is held on a list that can be read later.

Referring to FIG. 19, an example embodiment illustrates a situation when a note is too long to be read in the note detail window 372. In this case, the example embodiment offers the possibility to view the note in a different tab. This allows the user to be able to independently view or print the note from the separate tab. This feature of the example embodiment provides space for reading a note with fewer distractions on the display screen. In the example embodiment shown in FIG. 19, a comment area can be included with the note content in a common display area.

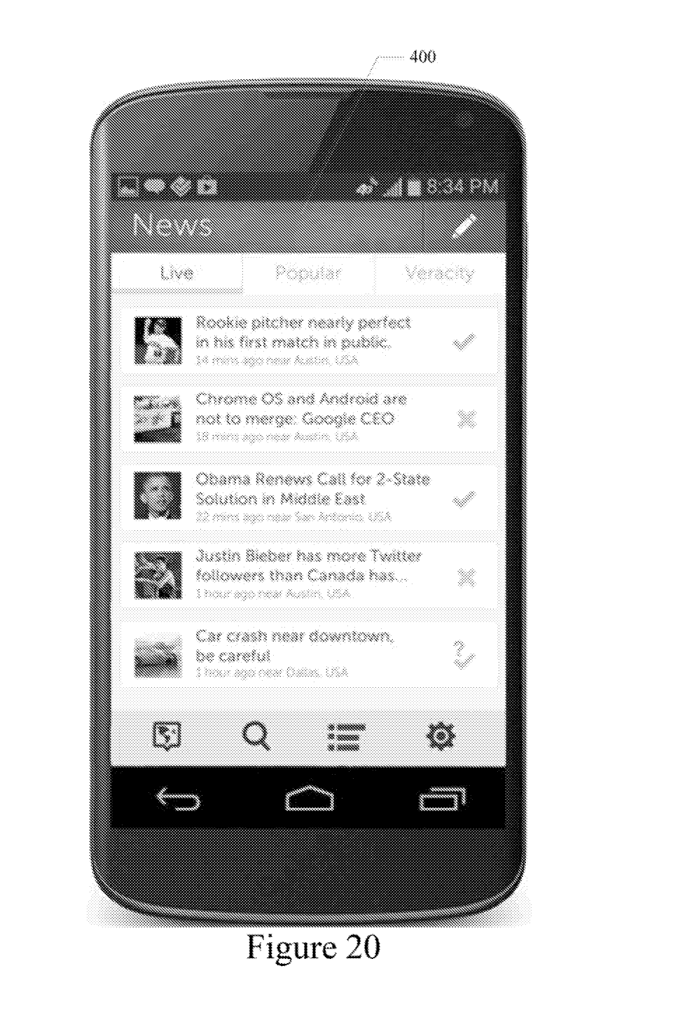

Referring again to FIG. 1, the geo-location based collaboration system 200 of an example embodiment can include a mobile management module 240. As described above, a user platform 141 can include a mobile device on which a mobile application (app) can be executed. Referring now to FIGS. 20 through 29, an example embodiment 400, implemented as a mobile device app with the mobile management module 240 therein, can be used to support a mobile device user interface for the geo-location based social networking system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant notes from a mobile device. As described in more detail below, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen displays a host logo and wallpaper image while opening the login screen or a live feed of posted notes.

User log-in functionality in the mobile app provides a user-friendly user interface in which the user provides the email address and password associated with the user account. If the user does not have an account, the user can create an account from this user interface. The process of creating a user account in an example embodiment is simple and only requires the user to provide the following information: name, surname, e-mail address, and password. By completing this information, the user can create an account and get access to news (e.g., notes) associated with the vicinity of the user's geographical location.

Referring now to FIG. 20, an example user interface snapshot 400, implemented as a mobile app, illustrates the basic elements of the user interface for viewing and manipulating notes on a mobile device. As shown in FIG. 20, the sample screenshot shows a live feed of note summaries or note headers. The mobile live feature of an example embodiment is a note feed, which provides a list of news or notes that include information on events happening at the time (e.g., notes that are time-stamped with a date/time that is a configurable length of time in the recent past from the present date/time). The user can use the scrolling mechanism on the mobile device to browse for news or notes that are proximate to the user's geo-location or a geo-location of interest. In an example embodiment as described above, the provided search engine allows the user to perform a search for notes by keywords (e.g., terms used in the title, content, or meta data of the note that match a search query), or a search for a specific geographical location and cause the display of all notes associated with that geo-location. The header of the mobile application provides access to a news and write tool icon, from which the user can create a note. In a notes list, each note appears with the image of the event associated with the note, the title and time in which the event occurred, as well as the location and level of accuracy (veracity indicator described above) associated with the note. A portion of the mobile live user interface provides a menu of tools with which the user can change location, search for notes using keywords, search for notes by category, filter notes, rate the veracity of notes, or change aspects of the user account settings.

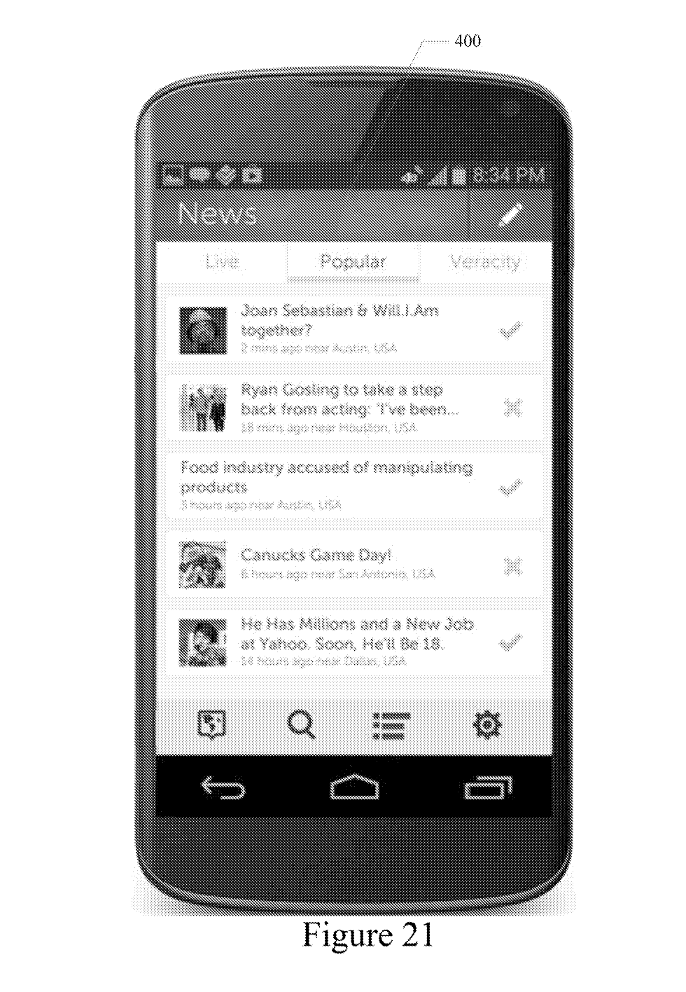

Referring now to FIG. 21, an example user interface snapshot 400, implemented as a mobile app, illustrates additional elements of the user interface for viewing and manipulating notes on a mobile device. As shown in FIG. 21, the sample screenshot shows a popular tool of an example embodiment that enables a user to filter and sort notes by popularity based on ratings provided by the community of users.

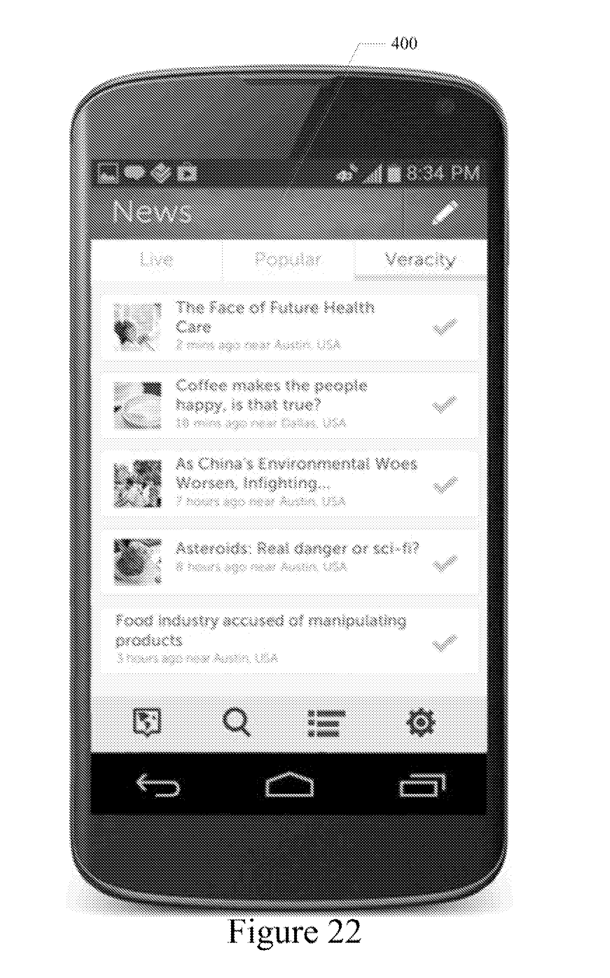

Referring now to FIG. 22, an example user interface snapshot 400, implemented as a mobile app, illustrates additional elements of the user interface for viewing and manipulating notes on a mobile device. As shown in FIG. 22, the sample screenshot shows a veracity tool of an example embodiment that enables a user to filter and sort notes by veracity based on veracity ratings provided by the community of users. The notes can be sorted by the degree of accuracy (e.g. the veracity indicator described above), in order for the user to read notes that are more reliable. The veracity tool can also be used to display only the notes the user has qualified as

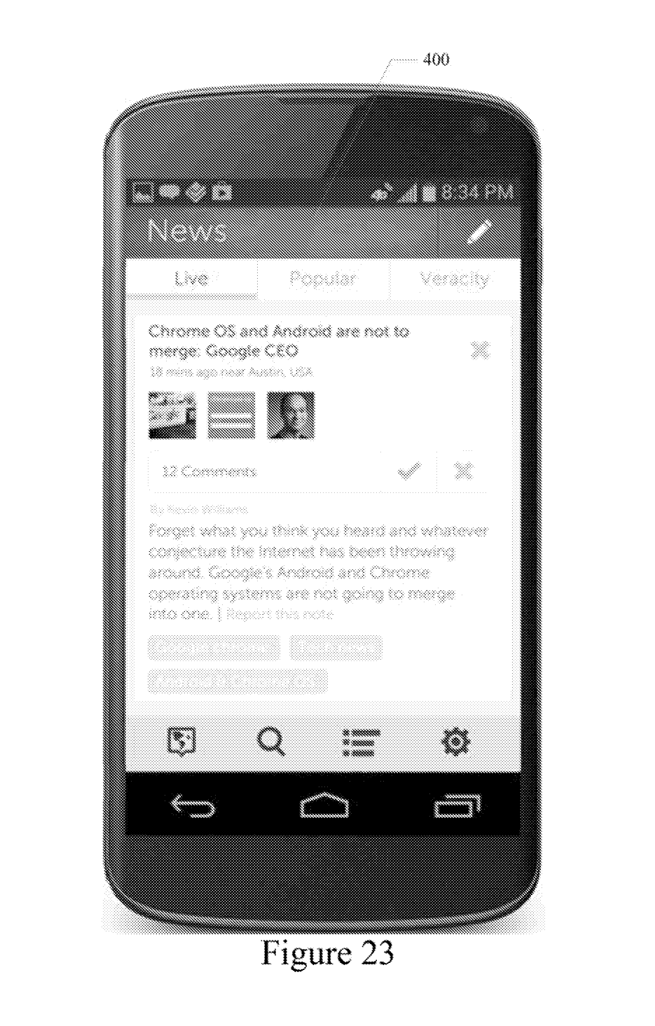

Referring now to FIG. 23, an example user interface snapshot 400, implemented as a mobile app, illustrates additional elements of the user interface for viewing and manipulating notes on a mobile device. When the user selects as note, detailed information related to the note is displayed through static displays or animations. When the user opens the note, the title of the note appears, the length of time the note has been published appears, and the geo-location associated with the note appears. The user can view a gallery of photos or other attachments associated with the note, first as a series of thumbnails from which the user can log in to view the attachments in full resolution. The user can view the number of comments associated with the note. The user can also view, edit, or add comments associated with the note by clicking on an icon associated with the note. The user has the option to rate the note as true or false. The user also has the option of reporting as note having inappropriate content.

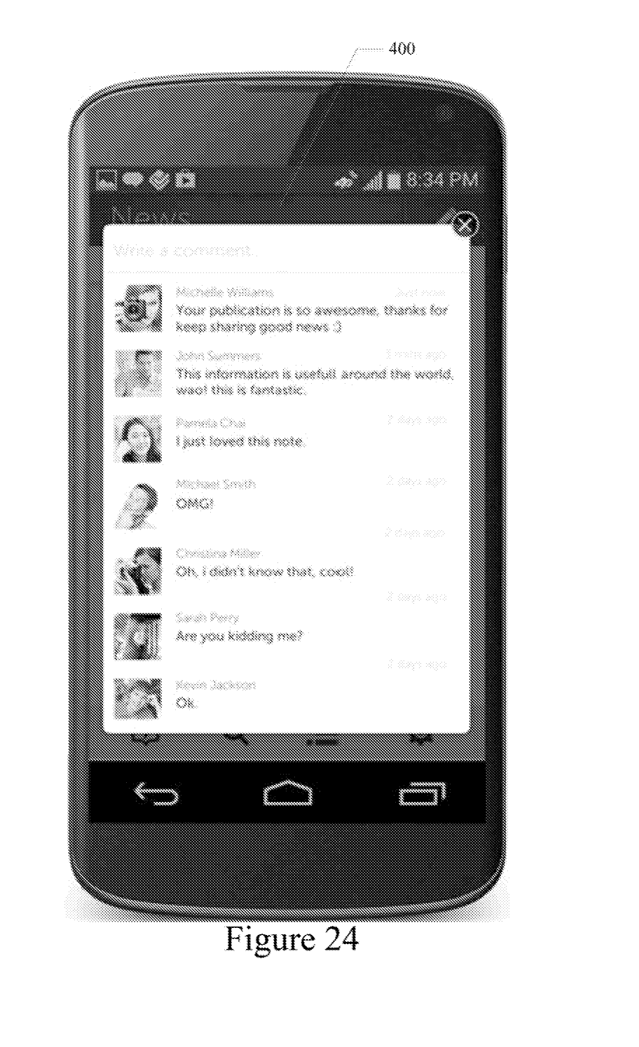

Referring now to FIG. 24, an example user interface snapshot 400, implemented as a mobile app, illustrates additional elements of the user interface for viewing and manipulating notes on a mobile device. As shown in FIG. 24, the sample screenshot shows how the user can write a comment associated with a note by pressing the write option to comment. The comment can be up to 4000 characters in an example embodiment. The comment appears as a popover adjacent to the note to which the comment relates. Comments can be ordered from the most recent to the first one that was generated for the note.

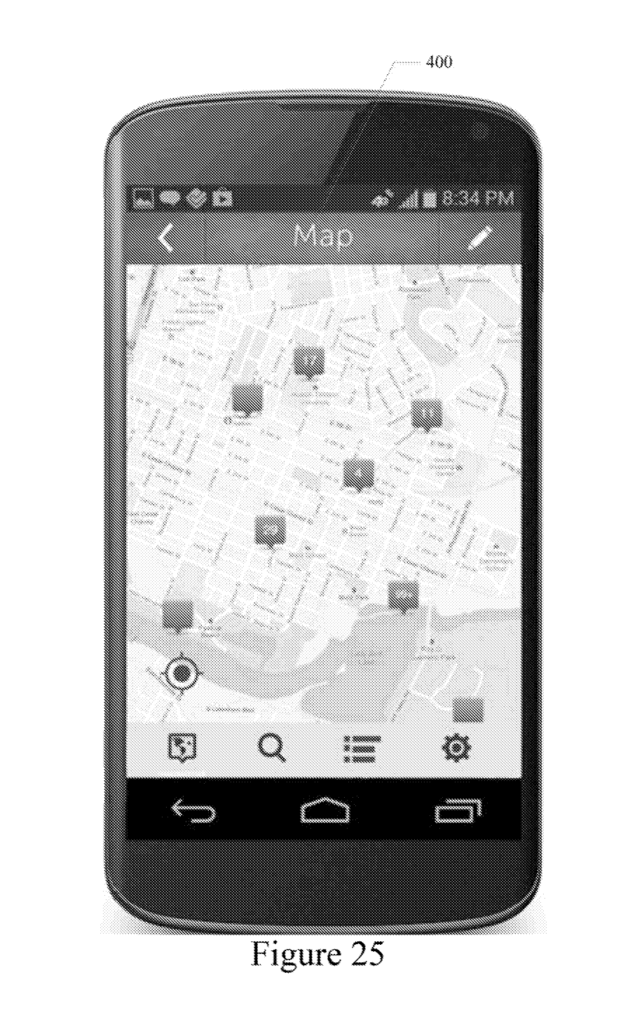

Referring now to FIG. 25, an example user interface snapshot 400, implemented as a mobile app, illustrates additional elements of the user interface for viewing and manipulating notes on a mobile device. As shown in FIG. 25, the sample screenshot shows how the user can browse the map to find notes attached to specific points or geo-locations on the map. In an example embodiment as described above, the provided search engine allows the user to perform a search for notes by keywords (e.g., terms used in the title, content, or meta data of the note that match a search query), or a search for a specific geographical location and cause the display of all notes associated with that geo-location. In an example embodiment, notes are represented on the map by an image of a blue pin (or other icon or marker) positioned at the geo-location on the map associated with the note. If there is more than one note associated with that geo-location, a number value indicating the quantity of notes associated with that geo-location is displayed. The user can zoom the map in or out. The map tool serves as a visual filter that allows the user to explore and find notes by geo-location on a mobile device.

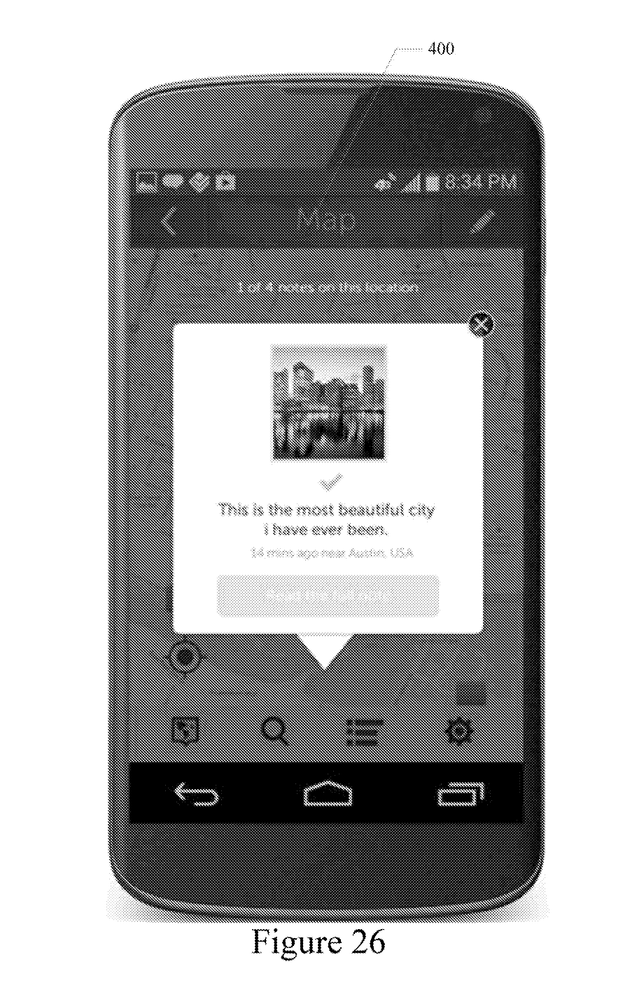

Referring now to FIG. 26, an example user interface snapshot 400, implemented as a mobile app, illustrates additional elements of the user interface for viewing and manipulating notes on a mobile device. As shown in FIG. 26, the sample screenshot shows the Infobox of an example embodiment as a preview of the note that is displayed when the user selects one blue pin (or other icon or marker) on the map. In the example embodiment, the Infobox is displayed as a pin-shaped card (or other icon), which is the image or representation of the note. The preview of the note provided by the Infobox feature of the example embodiment also includes information indicative of the veracity of the note (e.g., the veracity indicator which indicates whether the note is likely true or false based on input from the community of users), the title of the note, and the time/date and location associated with the note. If the user wishes to know more about the note, the user can click a read button to view the full contents of the note.

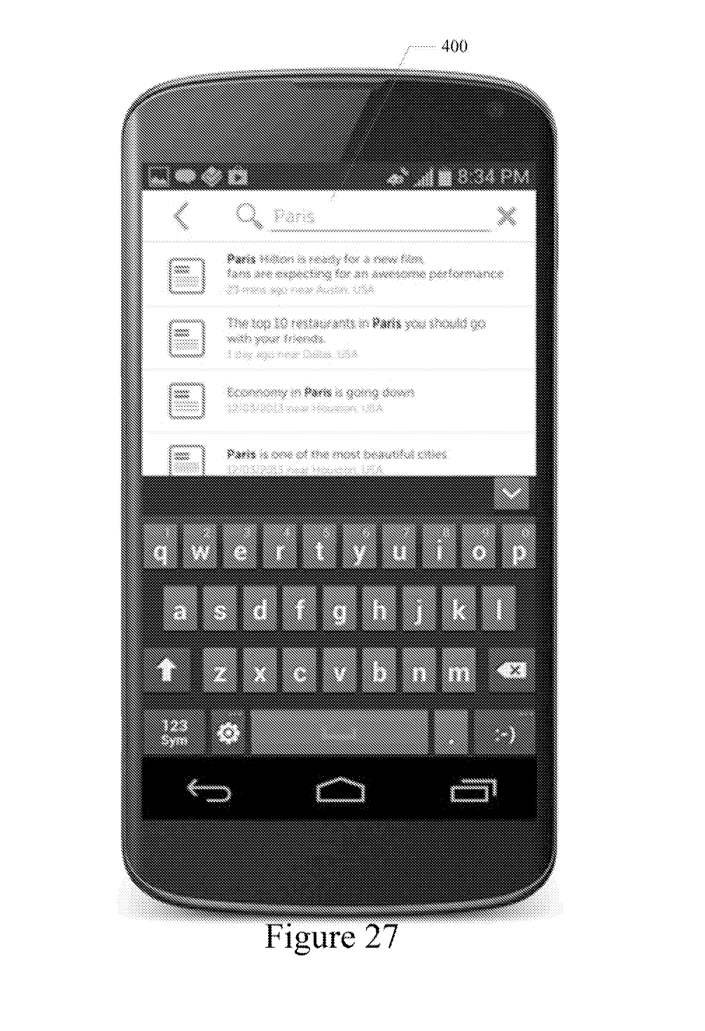

Referring now to FIG. 27, an example user interface snapshot 400, implemented as a mobile app, illustrates additional elements of the user interface for viewing and manipulating notes on a mobile device. As shown in FIG. 27, the sample screenshot shows how the user can search for notes using keywords. The search engine of the example embodiment responds in real time and yields relevant results.

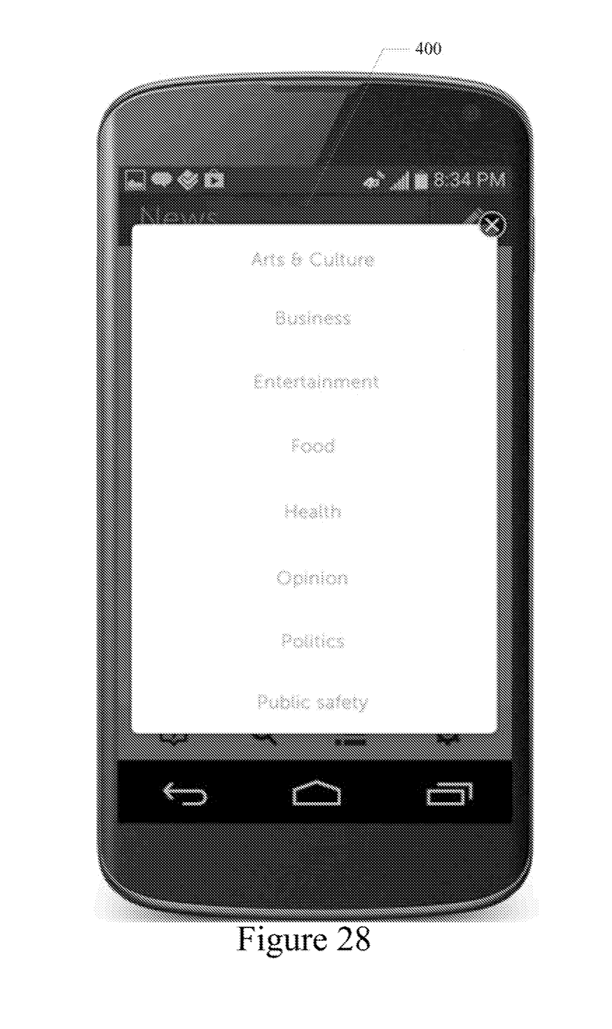

Referring now to FIG. 28, an example user interface snapshot 400, implemented as a mobile app, illustrates additional elements of the user interface for viewing and manipulating notes on a mobile device. As shown in FIG. 28, the sample screenshot shows how the user can select from a list of categories to see only notes associated with their interests as represented by the categories. The example embodiment also provides an option on the mobile interface to create a window where the user can complete the necessary information for the creation and publication of a note. The options include: add title and description of a note; add or remove photos or other attachments; select a geo-location associated with the note; choose a category associated with the note; and add keywords or tags associated with the note.

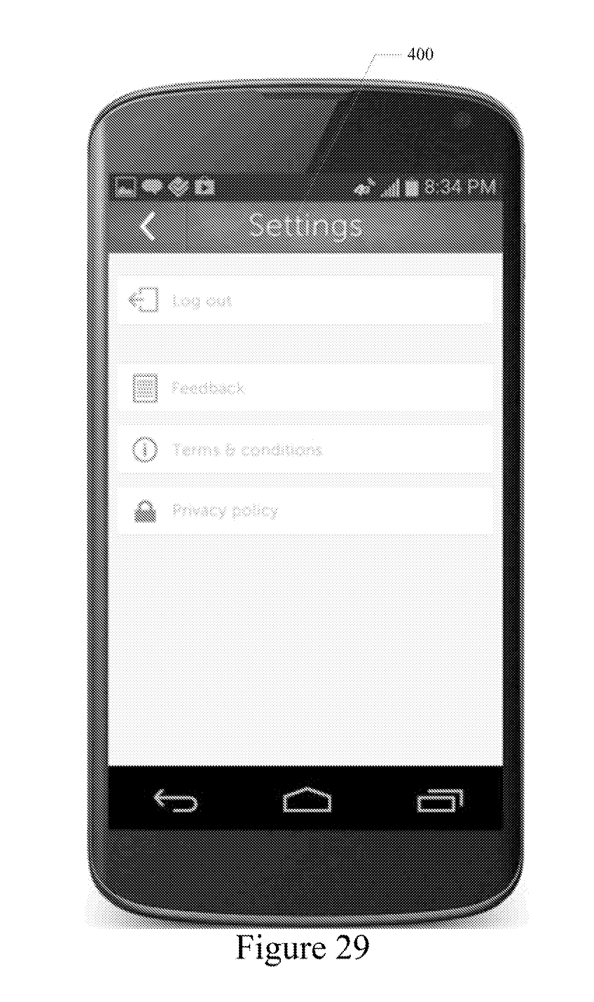

Referring now to FIG. 29, an example use interface snapshot 400, implemented as a mobile app, illustrates additional elements of the user interface for viewing and manipulating notes on a mobile device. As shown in FIG. 29, the sample screenshot shows how the user can employ the configuration user interface of the example embodiment to set various system and operational parameters and to view information about the terms and conditions of use and the privacy policy. The user can also set a default geo-location.

Referring again to FIG. 1, the geo-location based collaboration system 200 of an example embodiment is also shown to include a user account management module 250. The user account management module 250 can be used to create and maintain a user account on the host site 110. The user account management module 250 can also be used to configure user settings, create and maintain a user/user profile on host site 110, and otherwise manage user data and operational parameters on host site 110. In the example embodiment described herein, a user can register as an identified user in order to share notes, photos, documents, communications, or other content. The registered user can enter their name, email address, and their geo-location. Once this information is entered, a user account is created and the user can share notes, photos, documents, communications, or other content.

Referring again to FIG. 1, the geo-location based collaboration system 200 of an example embodiment is shown to include an administrative management module 260. The administrative management module 260 can be used by an agent of the gee-location based collaboration system 200 to manage user accounts and to manage the geo-location based collaboration system. The administrative management module 260 can also be used to enforce privacy protections and content controls for users. Moreover, the administrative management module 260 can also be used to generate and/or process as variety of analytics associated with the operation of the geo-location based collaboration system 200. For example, the administrative management module 260 can generate various statistical models that represent the activity of the community of users and related notes based on geographical location, note categories, user demographics, learned user behaviors, note content, note sharing, note advertising, and the like. These analytics can be shared, licensed, or sold to others.

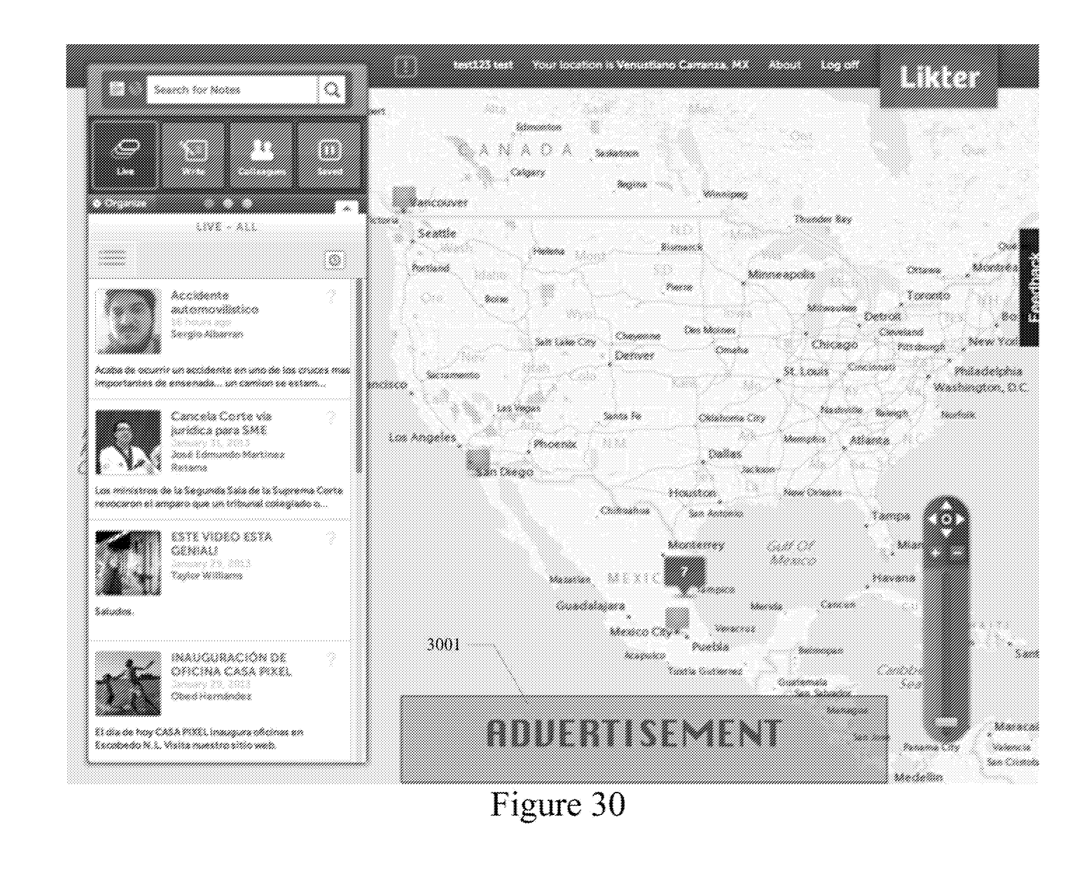

Referring now to FIGS. 30 through 32, the advertising features of an example embodiment are described and illustrated.

### Live Feed Ads

As described above, the user can use the console to search for notes using a content query, filter notes using a filtering tool, obtain access to notes via a recommendation from others, or obtain access to notes through a live feed. An example embodiment enables a user to view the live feed of the most recent notes corresponding to a portion of the map that is visible on the display screen at the time. Notes that are included in the live feed can be filtered based on user preferences and active filters configured with the Filter tool. Additionally, advertisements (ads) can be served to the user in combination with or as part of the notes in the live feed. The content of the served ads can be customized to correspond to the content of the notes in the live feed, the geo-locations corresponding to the note in the live feed, the events corresponding to the note in the live feed, or other relationships between the content or metadata of the notes in the live feed and the content of ads in an ad server. Various embodiments described herein add personalization to ads in order to increase click-through rates and improve the user experience. Ad recommendations can be enhanced using data to incorporate user personalization data as an additional weighting factor when choosing ad content. This data can include the following for selecting ads for a particular user: 1) previous buying habits, 2) previous search behavior, 3) previous host site path activity, 4) explicit user preferences and affinity as specified in the user's profile, and the like. Detection of a user's interaction with a note, generating keywords based on the user's interaction with the note, and performing a search using the keywords extracted from the user's interaction with the note can be used to identify ads that are most likely interesting to a particular user. For example, as program or app running on a client computer or mobile device may monitor the user's browsing activities on the host site or the Internet in general. When the user clicks on a link, information associated with the link, such as the link's label, may be parsed and an analysis process can be used to generate one or more keywords associated with the user's behavior. The user's profile can also be used to further filter or personalize the set of keywords. The set of keywords may be used to perform a search at an ad server to generate a set of ad content or impressions responsive to the keywords. The personalized ad content can be delivered to the user with related notes in the live feed in a variety of ways as described herein. Because the personalized ad content can be delivered to the user with related notes in the live feed, advertisers can bid for placement of advertising impressions in available display regions adjacent to or embedded in related notes of the live feed. Alternatively, advertisers can pay a fixed fee for placement of advertising impressions in available display regions adjacent to or embedded in related notes of the live feed. As a result, advertisers can have their advertising content served to highly relevant users who have already shown an interest in related notes of the live feed.

### Business Ads

Because the various embodiments described herein provide information collaboration based on geo-location, the digital map and related geo-location data are tightly integrated with the shared information. As a result, the various embodiments allow small businesses or other commercial enterprises to select an area on the map where they would like to have influence. Pricing for geo-location based advertising can be determined based on the size of the geographical area the business chooses for the advertising campaign, the life-span of the ad influence, the frequency at which ads are displayed, the size and location of the ad impressions, and the like. Any note that is opened within the area selected will contain an ad by the business that has selected that area, along with allowing the business to select a category in which their ads appear (e.g., food, sports, travel, entertainment, etc.). If different businesses select the same geographical area, various criteria can be used to balance the ad exposure between businesses equally or to skew the ad exposure more toward the business that selected a larger area, selected a longer ad run time, or earned more favorable treatment through established loyalty parameters.

Large businesses can use a similar concept, but with special attention towards clients that need a global influence. In this case, instead of selecting a particular area on the map, an embodiment can allow the client user to select a country, a set of countries, a region, a continent, or the like.

Ads Presented with the Digital Map

The various embodiments described herein use the digital map and related geo-location data to enable efficient collaboration and shared information. As a result, the digital map, or portions thereof, provide a valuable area in which to display ads. An example is shown in FIG. 30. Ad 3001 can be replaced with the personalized ad impressions as described above. The ad can be displayed as overlaying the digital map or adjacent to the digital map. Because users will spend a high percentage of their time viewing the content of the map and note icons displayed thereon, the ads also shown with or on the map will be likely viewed by the users as well. As such, the host can charge advertisers accordingly for the opportunity to have their ad content presented with or on the digital map.

Ads Presented with the Event Information

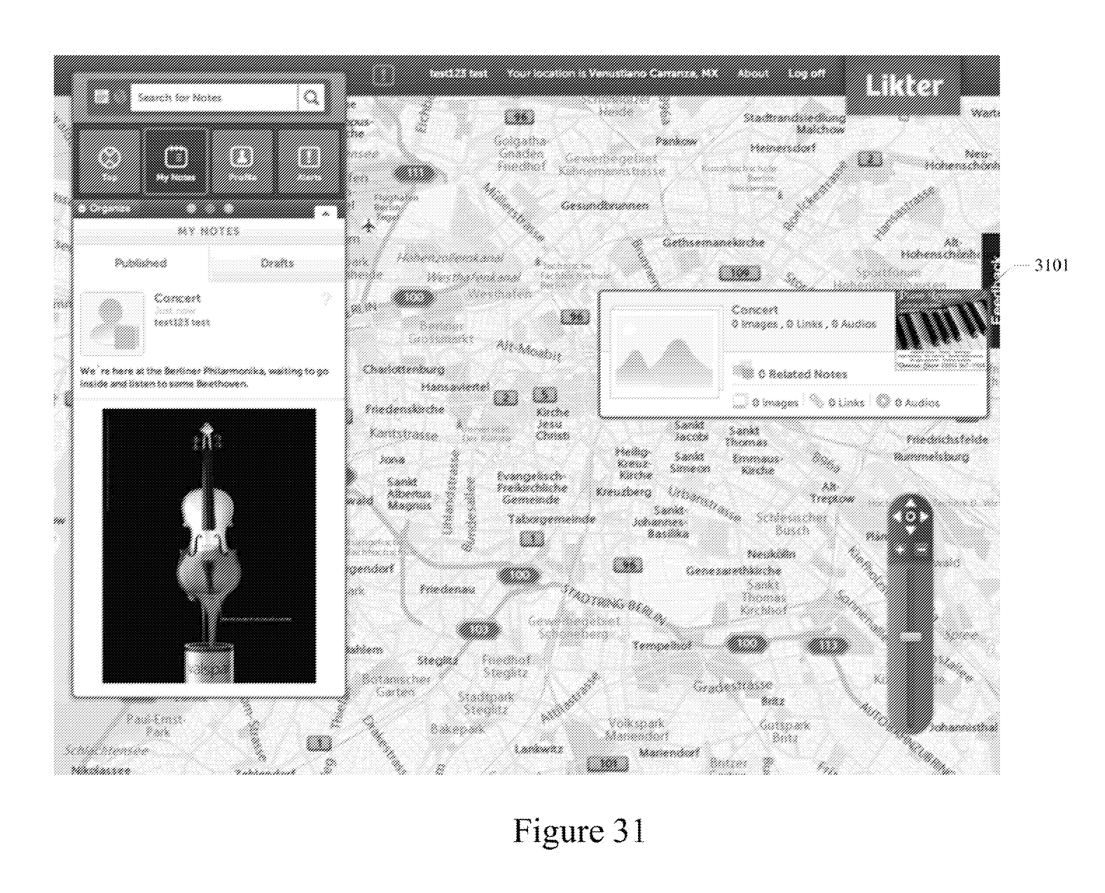

The various embodiments described herein use notes to share information and enable collaboration between users. In many cases, the content of the notes relate to events occurring in a particular location at a particular time (geo-temporal events). For example, a flurry of notes related to a tornado in Oklahoma or other news event may be generated and shared by a plurality of users. The notes related to the event can be connected using keywords, tags, categories, geo-location data, temporal data, or the like from the note content or note metadata. As another example, a set of notes may relate to an event, such as a classical concert scheduled for a particular date/time (e.g., see FIG. 31). Again, these notes can be related to the event using keywords, tags, categories, geo-location data, temporal data, or the like from the note content or note metadata. This same or similar set of keywords, tags, categories, geo-location data, temporal data, or the like can also be used to search for related ad content from an ad server. The related ads can be shown as ad impressions embedded within or adjacent to related notes. For example, the sample note related to a concert event as shown in FIG. 31 includes an ad impression 3101 advertising piano lessons, which can be related to the concert event to which the corresponding note relates. As a result, the note itself, or portions thereof, provide another valuable area in which or near which to display ads. The ad can be displayed as overlaying or embedded in the note or adjacent to the note. A separate display area for the ad can also be provided. Because users will spend a high percentage of their time viewing the content of notes, the ads also shown with or on the notes will be likely viewed by the users as well. As such, the host can charge advertisers accordingly for the opportunity to have their ad content presented with or on the related notes.

### On-Site Links Referencing Other Sites

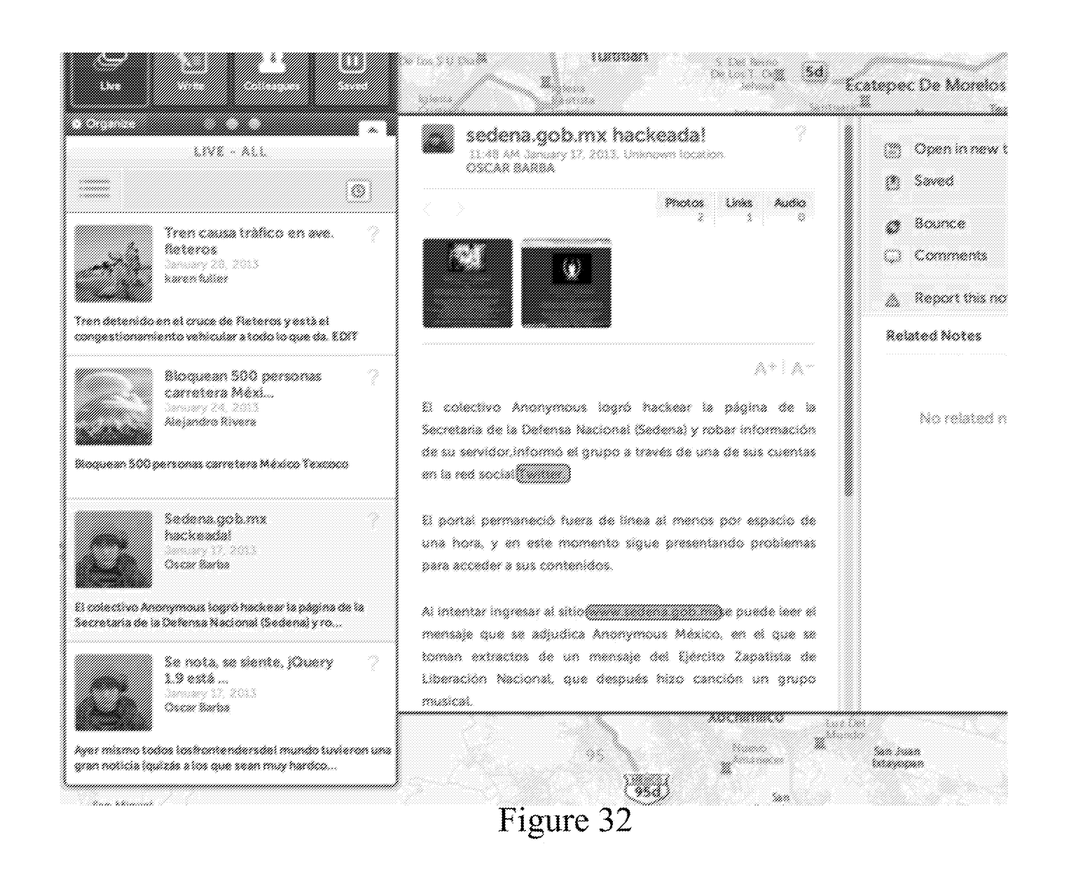

The various embodiments described herein use notes to share information and enable collaboration. The content of the notes can include hyperlinks or other mechanisms to connect an origination webpage to a destination webpage. The links in the notes can relate to or include keywords, tags, categories, or the like from the note content or note metadata. An example is shown in FIG. 32. This same or similar set of links, keywords, tags, categories, and the like can also be used to search for related content from as resource server. The content of articles or other references from a destination site can be linked or copied to a related note on the host site. Because a note can be filled with hyperlinks, a rich text editor can be provided for assisting the user in creating a note.

### Pro Accounts

As described above, users can originate and share notes. The host can also provide various types of advertising. However, the size and number of originated and shared notes must be limited for the average user to properly assign system resources and prevent abuse. In an example embodiment, a pro account status can be provided to enable a user to pay an extra fee and enable the user access to as larger number of system resources and enable the user to be exposed to a fewer number of advertising impressions. The amount of the additional fee (the pro account fee) can be commensurate with the cost of the additional system resources consumed by the pro user and/or the loss of the potential advertising revenue related to the pro user.

### Mobile App Monetization

As described above, users can originate and share notes using mobile devices. The host can provide various types of advertising on mobile devices as well. In an example embodiment, the app provided to the user for enabling the user to use the services provided as described herein can be implemented in a variety of functional tiers. A low level mobile app tier can be provided to basic users who pay a minimal amount for the app download and/or a minimal amount for a subscription to the host service. A second level mobile app tier can be provided to users who need a higher level of service and who pay a higher amount for the app download and/or a higher amount for a subscription to the host service. The second level tier mobile app can be configured to provide a higher level of functionality that the low level tier mobile app. The higher level of functionality can include higher bandwidth service, greater storage capacity, additional features, access to a greater number of information sources, and the like. For example, journalists or information professionals can be candidates for second level mobile app tier service. Additional mobile app tiers can also be provided for targeting various classes of users.

Although the various user interface displays provided by the example embodiments described herein are nearly infinitely varied, several sample user interface displays and sequences are provided herein and in the corresponding figures to describe various features of the disclosed embodiments. These sample user interface displays and sequences are described herein and in the accompanying figures. It will be apparent to those of ordinary skill in the art that equivalent user interface displays and sequences can be implemented within the scope of the inventive subject matter disclosed and claimed herein.

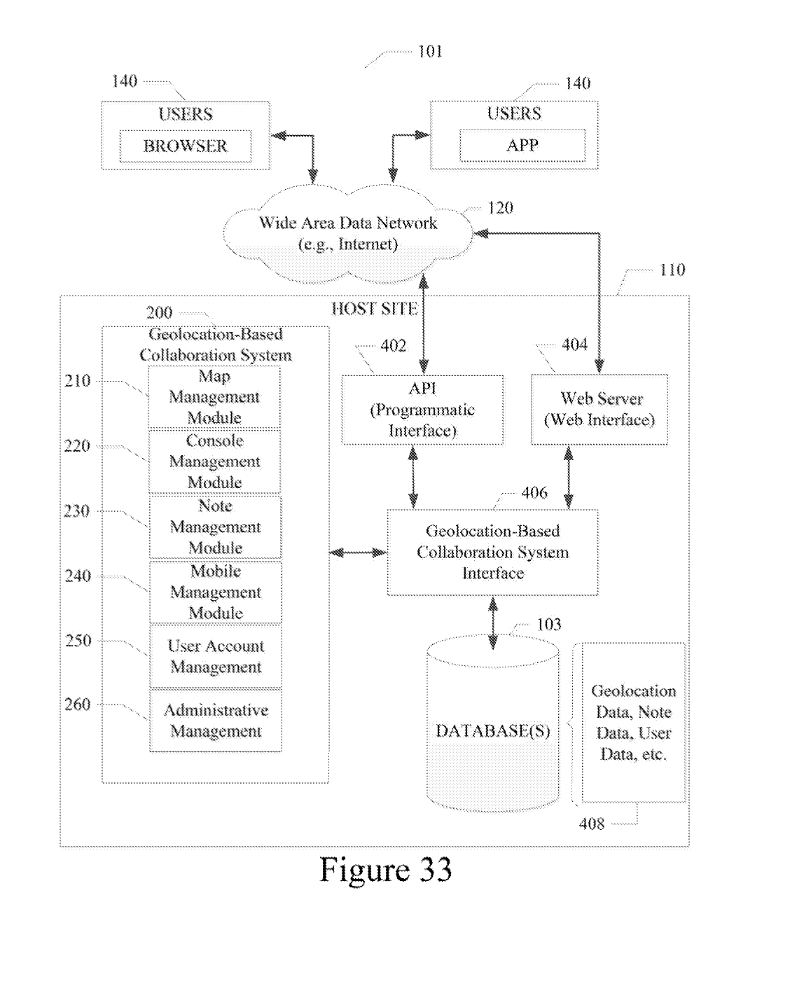

Referring now to FIG. 33, another example embodiment 101 of a networked system in which various embodiments may operate is illustrated. In the embodiment illustrated, the host site 110 is shown to include the geo-location based collaboration system 200. The geo-location based collaboration system 200 is shown to include the functional components 210 through 260, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The. API 402 and web interface 404 may be configured to interact with the geo-location based collaboration system 200 either directly or via an interface 406. The geo-location based collaboration system 200 may be configured to access a data storage device 103 and data 408 therein either directly or via the interface 405.

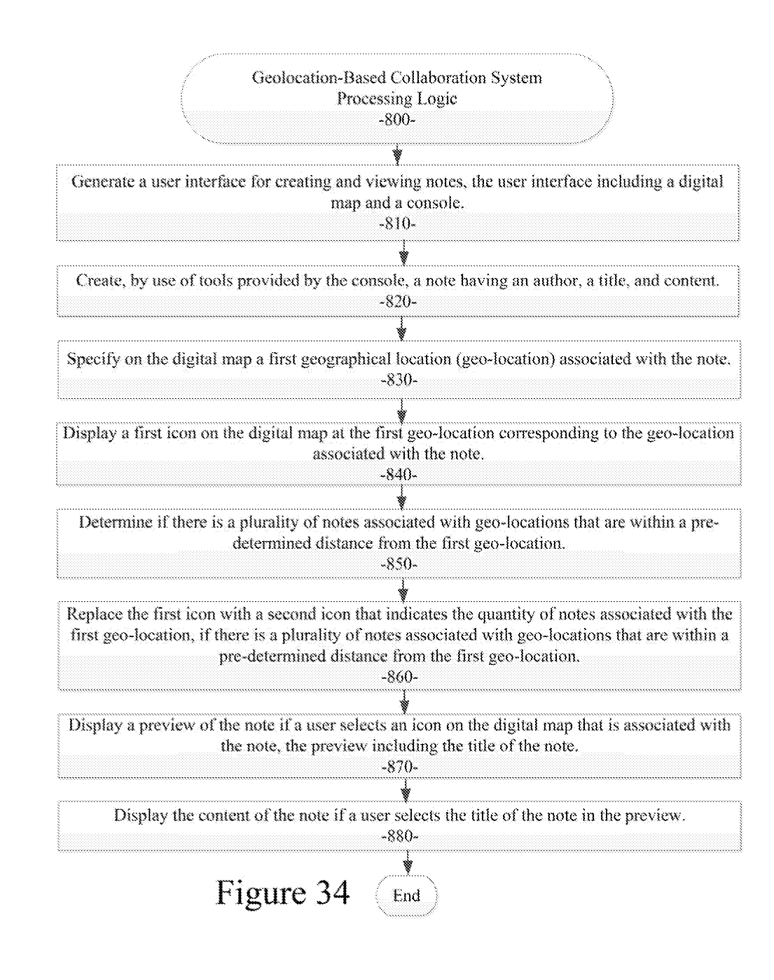

Referring now to FIG. 34, a processing flow diagram illustrates an example embodiment of a geo-location based collaboration system 200 as described herein. The method 800 of an example embodiment includes: generating, by execution of a data processor, a user interface for creating and viewing notes, the user interface including a digital map and a console (processing block 810); creating, by use of tools provided by the console, a note having an author, a title, and content (processing block 820); specifying on the digital map a first geographical location (geo-location) associated with the note (processing block 834, displaying a first icon on the digital map at the first geo-location corresponding to the geo-location associated with the note (processing block 840); determining if there is a plurality of notes associated with geo-locations that are within as pre-determined distance from the first geo-location (processing block 850); replacing the first icon with a second icon that indicates the quantity of notes associated with the first geo-location, if there is a plurality of notes associated with geo-locations that are within a pre-determined distance from the first geo-location (processing block 860); displaying a preview of the note if a user selects an icon on the digital map that is associated with the note, the preview including the title of the note (processing block 870); and displaying the content of the note if a user selects the title of the note in the preview (processing block 880).

As described herein, an example embodiment can perform a method of generating an alert associated with a note, the method comprising: selecting at least one word; graphically selecting a geographical area on a digital map; detecting that a note posted on the Internet contains the at least one word and is associated with a geographical location within the geographical area; and generating the alert, the alert being indicative of the at least one word and the geographical location.

As described herein, an example embodiment can perform a method of receiving a first digital picture, a first caption associated with the first digital picture, and a first geographical location associated with the first digital picture, wherein the first geographical location is selected graphically using a first digital map, considering the function of time; receiving a second digital picture, a second caption associated with the second digital picture, and a second geographical location associated with the second digital picture, wherein the second geographical location is selected graphically using a second digital map; determining that the first caption and the second caption have at least one word in common; determining that the first geographical location is within a predetermined distance from the second geographical location placing the first digital picture, the first caption, the second digital picture, and the second caption in the gallery of digital pictures; and associating the gallery of digital pictures with a geographical area and time period that includes the first geographical location and the second geographical location.

As described herein, an example embodiment can perform to method of receiving as first note at a first time, the first note being associated with a first geographical location; receiving a second note at a second time, the second note being associated with a second geographical location; receiving a third note at a third time, the third note being associated with a third geographical location; receiving as graphical selection of a geographical area on a digital map, the geographical area including the first geographical location and the second geographical location, but excluding the third geographical location; receiving a selection of a time period that includes the first time period and the third time period, but excludes the second time period; displaying the first note; and hiding the second note and the third note.

As described herein, an example embodiment can perform a method of displaying a credibility badge associated with any source or user, the method comprising: receiving a plurality of notes associated with a plurality of geographical locations from a source user, wherein the plurality of geographical locations area graphically selected on a digital map; receiving votes associated with the plurality of notes from a plurality of users other than the source user; determining that the source user has earned a predetermined number of votes; and displaying the credibility badge in association with at least one note posted by the source user.

As described herein, an example embodiment can perform a method of receiving a first digital advertisement and a first geographical area associated with the first digital advertisement, wherein the first geographical area is selected graphically using a first digital map and the first geographical area has a first size; receiving a second digital advertisement and a second geographical area associated with the second advertisement, wherein the second geographical area is selected graphically using a second digital map and the second geographical area has a second size, the first geographical area and the second geographical area defining an overlapping geographical area where at least a portion of the first geographical area overlaps at least as portion of the second geographical area; receiving a first note associated with a first geographical location inside the overlapping geographical area; selecting one of the first digital advertisement and the second digital advertisement based at least in part on the first size and the second size; and displaying the note with the selected digital advertisement.

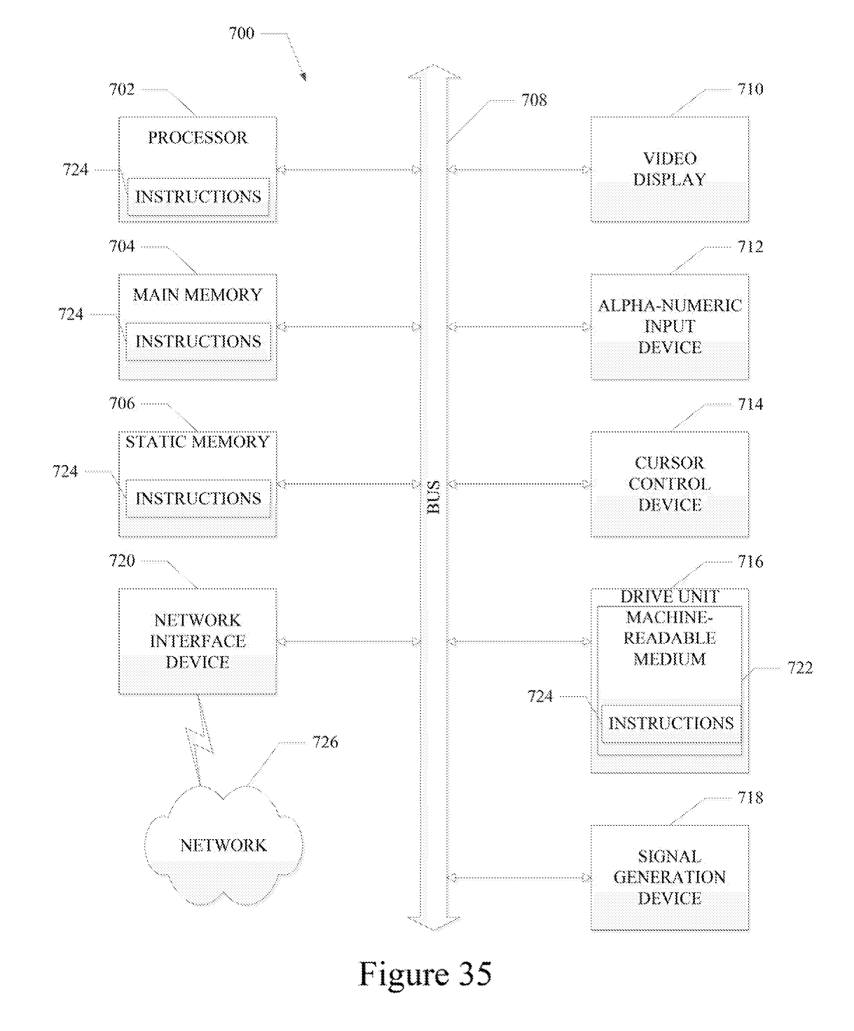

FIG. 35 shows a diagrammatic representation of a machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple non-transitory media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 CFR. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
generating, by execution of a data processor, a user interlace for creating and viewing notes, the user interface including a digital map and a console;
creating, by use of tools provided by the console, a note having an author, a title, and content;
specifying on the digital map a first geographical location (geo-location) associated with the note;
displaying a first icon on the digital map at the first geo-location corresponding to the geo-location associated with the note;
determining if there is a plurality of notes associated with geo-locations that are within a pre-determined distance from the first geo-location;
replacing the first icon with a second icon that indicates the quantity of notes associated with the first gee-location, if there is a plurality of notes associated with gee-locations that are within a pre-determined distance from the first gee-location;
displaying a preview of the note if a user selects an icon on the digital map that is associated with the note, the preview including the title of the note; and
displaying the content of the note if a user selects the title of the note in the preview.

2. The method as claimed in claim 1 wherein the user interface is generated as a web application.

3. The method as claimed in claim 1 wherein the user interface is generated as a mobile application.

4. The method as claimed in claim 1 further including bouncing the note from a first user to a second user.

5. The method as claimed in claim 1 further including displaying an alert for a second user when the note is bounced from a first user to the second user.

6. The method as claimed in claim 1 further including displaying a credibility indicator associated with each user.

7. The method as claimed in claim 1 further including creating a filter to establish filtering criteria to manage the notes that appear to the user.

8. The method as claimed in claim 1 wherein the content of the note can include text, images hyperlinks, video, and audio.

9. The method as claimed in claim 1 further including submitting a vote related to the note, the vote including an indication that the note is either true or fake, an aggregation of votes from a plurality of users being displayed with each note as a veracity indicator.

10. The method as claimed claim 1 further including displaying related notes and tags associated with the note.

11. A system comprising:
a data processor;
a network interface, in data communication with the data processor, for communication on a data network; and
a collaboration system based on geographical location, executable by the data processor, to:
generate a user interface for creating and viewing notes, the user interface including a digital map and a console;
create, by use of tools provided by the console, a note having an author, a title, and content;
specify on the digital map a first geographical (geo-location) associated with the note;
display a first icon on the digital map at the first geo-location corresponding to the geo-location associated with the note;
determine if there is a plurality of notes associated with geo-locations that are within a pre-determined distance from the first geo-location;
replace the first icon with a second icon that indicates the quantity of notes associated with the first geo-location, if there is a plurality of notes associated with geo-locations that are within a pre-determined distance from the first geo-location;
display a preview of the note if a user selects an icon on the digital map that is associated with the note, the preview including the title of the note; and
display the content of the note if a user selects the title of the note in the preview.

12. The system as claimed in claim 11 wherein the user interface is generated as a web application.

13. The system as claimed in claim 11 wherein the user interface is generated as a mobile application.

14. The system as claimed in claim 11 being further configured to bounce the note from a first user to a second user.

15. The system as claimed in claim 11 being further configured to display an alert for a second user when the note is bounced from a first user to the second user.

16. The system as claimed in claim 11 being further configured to display a credibility indicator associated with each user.

17. The system as claimed in claim 11 being further configured to create as filter to establish filtering criteria to manage the notes that appear to the user.

18. The system as claimed in claim 11 wherein the content of the note can include text, images, hyperlinks, video, and audio.

19. The system as claimed in claim 11 being further configured to submit a vote related to the note, the vote including an indication that the note is either true or fake, an aggregation of votes from a plurality of users being displayed with each note as a veracity indicator.

20. A non-transitory machine-usable storage medium embodying instructions which, when executed by a machine, cause the machine to:
generate a user interface for creating and viewing notes, the user interface including a digital map and a console;
create, by use of tools provided by the console, a note having an author, a title, and content;
specify on the digital map a first geographical location (geo-location) associated with the note;
display a first icon on the digital map at the first geo-location corresponding to the geo-location associated with the note;
determine if there is a plurality of notes associated with geo-locations that are within a pre-determined distance from the first geo-location;
replace the first icon with a second icon that indicates the quantity of notes associated with the first geo-location, if there is a plurality of notes associated with geo-locations that are within a pre-determined distance from the first geo-location;
display a preview of the note if a user selects an icon on the digital map that is associated with the note, the preview including the title of the note; and
display the content of the note if a user selects the title of the note in the preview.
